(19) United States
(12) Patent Application Publication
(10) Pub. No.: US 2004/0144189 A1
(43) Pub. Date: Jul. 29, 2004

(54) Drive gear and disk device with the drive gear

(76) Inventors: Mitsunori Nakamura, Kanagawa (JP); Toyokazu Arai, Kanagawa (JP); Satoru Manabe, Kanagawa (JP)

Correspondence Address: Patents & TMS, A Professional Corparation, 1914 North Milwaukee Avenue, Chicago, IL, 60647, US

(21) Appl. No.: 10/473,708

(22) PCT Filed: Mar. 28, 2002
(86) PCT No.: PCT/JP02/03121

(30) Foreign Application Priority Data
Mar. 30, 2001 (JP) 2001-102643

(51) Int. Cl. F16H 27/02

(52) U.S. Cl. 74/89.18

(57) ABSTRACT

It is an object to provide a drive gear capable of mating with a mating gear smoothly and a disc drive equipped with the drive gear. A pinion gear 610 is a drive gear to be arranged on an axis for transmitting rotational force to a large gear 631 of a first gear 630 as the mating gear arranged on another axis, the pinion gear 610 being adapted to be mated with the large gear 631 by moving the large gear 631 as one of these gears in a state where the pinion gear 610 as the other gear of these gears is being fixed on the axis thereof. The pinion gear 610 includes a roughly cylindrical body portion 611, a plurality of teeth 612 provided on the outer circumferential surface of the body portion 611, each of the plurality of teeth 612 having two tooth surfaces 613, 613 and both end portions in the direction of the axis, and guiding surfaces 614 for guiding teeth of the large gear 631 to the tooth surfaces 613 when these gears are mated, each of the guiding surfaces 614 being formed in at least the one end portion of each of the plurality of teeth 612 of the pinion gear 610.

### FIELD OF THE INVENTION

The present invention relates to a drive gear for carrying out loading operation when a disc is loaded on a disc tray, and to a disc drive equipped with the drive gear.

### DESCRIPTION OF THE PRIOR ART

FIGS. 57(a) and (b) are respectively a top plan view and a side view of a driving gear used in the prior art disc drive. FIG. 58 is an explanatory drawing which shows a positional relationship when the prior art drive gear is mounted to a mating gear.

A drive gear 78 that is a spur gear used in a disc tray open/close mechanism and the like of a conventional disc drive is formed from resin or the like. As shown in FIGS. 57(a) and (b), the drive gear includes a roughly cylindrical body portion 781 inserted on a motor or a rotation shaft, and a plurality of teeth 782 provided on the outer circumferential surface of the body portion 781 and protruding roughly linearly in the central axis of the body portion 781.

There is a case where protrusions such as burrs and the like arise on the end surface of each of the teeth when a drive gear 78 is molded. As shown in FIG. 58, when the drive gear 78 and a mating gear 79 are mated by relatively moving one of these gears with respect to the other gear with a parallel position relationship between the center axis of the drive gear 78 and the center axis of the mating gear 79, the above-mentioned protrusions become an obstacle to mating with the mating gear 79. Further, in the case where the one gear 78 or 79 is forced into the other gear 79 or 78 forcedly in spite of the presence of such protrusions, there may be a possibility to crush the teeth of the drive gear 78 or the mating gear 79.

### DISCLOSURE OF THE INVENTION

In view of the above mentioned problem, it is an object of the present invention to provide a drive gear capable of mating with a mating gear smoothly and a disc drive equipped with the drive gear.

In order to achieve the above object, the present invention is directed to a drive gear to be arranged on an axis for transmitting rotational force to a mating gear arranged on another axis, the drive gear being adapted to be mated with the mating gear by moving one of the drive gear and the mating gear in a state where the other gear of these gears is being fixed on the axis thereof, the drive gear comprising: a roughly cylindrical body portion; a plurality of teeth provided on the outer circumferential surface of the body portion, each of the plurality of teeth having two tooth surfaces and both end portions in the direction of the axis; and guiding surfaces for guiding teeth of the mating gear when these gears are mated, each of the guiding surfaces being formed in at least the one end portion of each of the plurality of teeth of the drive gear.

According to the drive gear of the present invention, because there is guiding surfaces for guiding teeth of the mating gear to the tooth surfaces of the drive gear, the teeth of the mating gear can be guided to the tooth surfaces of the drive gear smoothly by the guiding surfaces when these gears are mated. Therefore, it is difficult for these gears to be damaged when they are mated, the production cost of the drive gear can be reduced, and efficiency of production process of the drive gear can be improved.

In the present invention, it is preferred that each tooth surface having both ends at the end portions, and each of the guiding surfaces is continuously formed with the end of the tooth surface at the one end portion thereof so as to form an obtuse angle with respect to the tooth surface.

Further, it is also preferred that the guiding surfaces are continuously formed with the ends of the two tooth surfaces of each of the plurality of teeth, respectively.

Furthermore, it is also preferred that the drive gear further comprises guiding grooves for guiding the teeth of the mating gear, each guiding groove being provided between the adjacent two teeth of the drive gear.

Moreover, it is also preferred that each guiding groove is continuously formed with the opposed guiding surfaces of the adjacent two teeth.

Further, it is also preferred that each of the plurality of teeth is formed with a chamfer surface at least at the one end portion thereof so as to form an acute angle with respect to the outer circumferential surface of the body portion.

Furthermore, it is also preferred that the drive gear is formed from a material having a higher hardness than the mating gear.

Another aspect of the present invention is directed to a disc drive having the drive gear having the above structures. teeth of the mating gear can be guided to the tooth surfaces of the drive gear smoothly by the guiding surfaces when these gears are mated. Therefore, it is difficult for these gears to be damaged when they are mated, the production cost of the drive gear can be reduced, and efficiency of production process of the drive gear can be improved.

In the present invention, it is preferred that each tooth surface having both ends at the end portions, and each of the guiding surfaces is continuously formed with the end of the tooth surface at the one end portion thereof so as to form an obtuse angle with respect to the tooth surface.

Further, it is also preferred that the guiding surfaces are continuously formed with the ends of the two tooth surfaces of each of the plurality of teeth, respectively.

Furthermore, it is also preferred that the drive gear further comprises guiding grooves for guiding the teeth of the mating gear, each guiding groove being provided between the adjacent two teeth of the drive gear.

Moreover, it is also preferred that each guiding groove is continuously formed with the opposed guiding surfaces of the adjacent two teeth.

Further, it is also preferred that each of the plurality of teeth is formed with a chamfer surface at least at the one end portion thereof so as to form an acute angle with respect to the outer circumferential surface of the body portion.

Furthermore, it is also preferred that the drive gear is formed from a material having a higher hardness than the mating gear.

Another aspect of the present invention is directed to a disc drive having the drive gear having the above structures.

These and other objects, structures and advantages of the present invention will be more apparent when the following detailed description of the preferred embodiment is considered taken in conjunction with the appended drawings.

### BRIEF DESCRIPTION OF THE DRAWINGS

FIG. 1 is a perspective view showing the overall structure of a disc drive according the present invention.

FIG. 2 is a top view of a main unit of the disc drive according to the present invention.

FIG. 3 is a front view of a front bezel of the disc drive according to the present invention.

FIG. 4 is a cross-sectional view taken along the line A-A of FIG. 3.

FIGS. 5(a) and (b) are respectively enlarged views of a concave portion and a guide groove portion of the front bezel of the disc drive according to the present invention.

FIG. 6(a) is a cross-sectional view taken along the line B-B in FIG. 5(a), and

FIG. 6(b) is a cross-sectional view taken along the line C-C in FIG. 5(b).

FIG. 7 is a front view of the shutter of the disc drive according to the present invention.

FIG. 8 is a right side view of the shutter of the disc drive according to the present invention.

FIG. 9 is an enlarged view of a shank of the shutter of the disc drive according to the present invention.

FIG. 10 is an explanatory view showing the positional relationship when the shutter of the disc drive of the present invention is mounted to the front bezel.

FIG. 11 is a top view of a disc tray of the disc drive according to the present invention.

FIG. 12 is a bottom view of the disc tray of the disc drive according to the present invention.

FIG. 13(a) is a cross-sectional view taken along the line D-D in FIG. 11, and

FIG. 13(b) is an illustration which shows a state that a bottom surface of a disc makes contact with a guiding slant surface of the disc tray shown in FIG. 13(a).

FIG. 14 is a top view of the chassis of the disc drive according to the present invention.

FIG. 15 is a vertical cross-sectional view of a portion in the vicinity of a rail provided in the chassis of the disc drive according to the present invention.

FIG. 16 is a top view of a base frame of a mechanism unit of the disc drive according to the present invention.

FIG. 17 is a top view of a holding member of the mechanism unit of the disc drive according to the present invention.

FIG. 18 is a bottom view of the holding member of the mechanism unit of the disc drive according to the present invention.

FIG. 19 is a top view of an optical pick-up moving mechanism of the disc drive according to the present invention.

FIG. 20 is an enlarged view of an engagement portion provided at the right side of an optical pick-up of the disc drive according to the present invention.

FIG. 21 is a top view showing an essential portion of a thrust load pushing mechanism of the optical pick-up moving mechanism of the disc drive according to the present invention.

FIG. 22 is a top view of the pushing member of the thrust load pushing mechanism of the disc drive according to the present invention.

FIG. 23 is a side view of the pushing member of the thrust load pushing mechanism of the disc drive according to the present invention.

FIG. 24 is a top view of the support member of the thrust load pushing mechanism of the disc drive according to the present invention.

FIG. 25 is a cross-sectional view taken along the line E-E of FIG. 24.

FIG. 26 is a cross-sectional view taken along the line F-F of FIG. 24.

FIGS. 27(a) and 27(b) are top views showing the states in which a loading drive mechanism and a cam member of a cam mechanism of the disc drive according to the present invention are respectively at a first position and a second position.

FIGS. 28(a) through 28(c) are respectively a top view, a front view and a leftside view of the cam member of the cam mechanism of the disc drive according to the present invention.

FIGS. 29(a) and (b) are respectively a top view which shows a main part of the loading drive mechanism and the cam mechanism of the disc rive according to the present invention.

FIGS. 30(a) and 30(b) are respectively a front view and a side view of a disc tray position detecting switch of the disc drive according to the present invention.

FIGS. 31(a) and 31(b) are front views respectively showing the states of the disc tray position detecting switch of the disc drive according to the present invention when a detection lever is inclined to the left side and the right side.

FIGS. 32(a) through 32(c) are respectively a top view, a front view and a side view of a slider of the disc tray position detecting mechanism of the disc drive according to the present invention.

FIGS. 33(a) and 33(b) are respectively a top view and a side view of a pinion gear of the loading drive mechanism of the disc drive according to the present invention.

FIG. 34 is an enlarged perspective view of an essential portion of the pinion gear of the disc drive according to the present invention.

FIG. 35 is a top view of a first rotation shaft of the loading drive mechanism of the disc drive according to the present invention.

FIG. 36 is a side view of the first rotation shaft of the loading drive mechanism of the disc drive according to the present invention.

FIG. 37 is a bottom view of a gear arm of the loading drive mechanism of the disc drive according to the present invention.

FIG. 38 is a cross-sectional view taken along the line G-G of FIG. 37.

FIGS. 39(a) and 39(b) are respectively a top view and a side view of a second gear of the loading drive mechanism of the disc drive according to the present invention.

FIG. 40 is a right side view showing the essential portion of a skew adjustment mechanism of the optical pick-up of the disc drive according to the present invention.

FIG. 41 is a cross-sectional view showing the essential portion of the skew adjustment mechanism of the optical pick-up of the disc drive according to the present invention.

FIG. 42 is a top view of a guide rod pushing spring of the skew adjustment mechanism of the disc drive according to the present invention.

FIG. 43 is a side view of a guide rod pushing spring of the skew adjustment mechanism of the disc drive according to the present invention.

FIG. 44 is a top view of a guide rod holding member of the skew adjustment mechanism of the disc drive according to the present invention.

FIG. 45 is a top view, a bottom view and a side view of a guide rod holding member of the skew adjustment mechanism of the disc drive according to the present invention.

FIG. 46 is a side view of a guide rod holding member of the skew adjustment mechanism of the disc drive according to the present invention.

FIG. 47 is an explanatory view showing the process for mounting the guide rod holding members of the skew adjustment mechanism of the disc drive according to the present invention to the holding member of the mechanism unit.

FIG. 48 is a front view of a front bezel of a prior art disc drive.

FIG. 49 is a front view of a shatter of the prior art disc drive.

FIG. 50(a) is a top view of the shutter of the prior art disc drive, and

FIG. 50(b) is an illustration which schematically shows the external force with the arrow applied when the shatter is mounted to the front bezel.

FIG. 51 is a bottom view of a disc tray of the prior art disc drive

FIG. 52 is a top plan view of the disc tray of the prior art disc drive.

FIGS. 53(a) and (b) are illustrations which respectively show the states that a cam member provided in a disc tray position detection mechanism provided in the main unit of the prior art disc drive is at a first position and a second position.

FIG. 54 is a cross-sectional view taken along the line the H-H in FIG. 52.

FIG. 55 is a cross-sectional view which schematically shows a state that a disc is placed on the disc tray.

FIG. 56 is an exploded perspective view which shows an example of a pick-up base of the prior art disc drive.

FIGS. 57(a) and (b) are respectively a top plan view and a side view of a driving gear used in the prior art disc drive.

FIG. 58 is an explanatory drawing which shows a positional relationship when the prior art drive gear is mounted to a mating gear.

### BEST MODE FOR PRACTICING THE INVENTION

The preferred embodiments of a disc drive according to the present invention are described below with reference to the appended drawings.

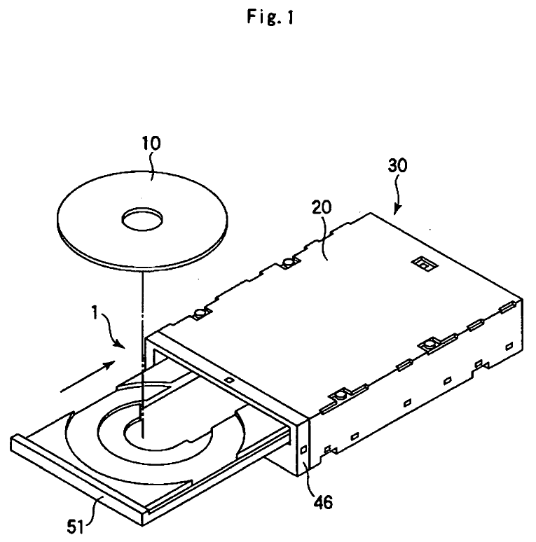

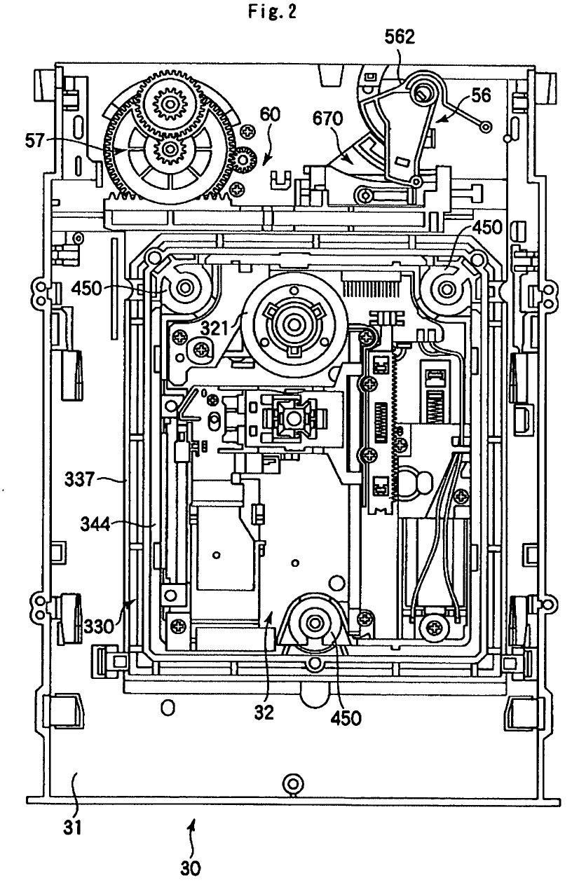

FIG. 1 is a perspective view showing the overall structure of a disc drive of the present invention, and FIG. 2 is a top view of a main unit of the disc drive.

As shown in FIG. 1, the disc drive 1 is an optical disc drive which carries out playback (reproducing) or recording/playback operation on a disc 10 such as a CD, DVD or the like. The disc drive 1 is generally constructed from a main unit 30 (see FIG. 2) housed in a casing 20, and a disc tray 51 for conveying the disc 10 which is movable in the forward and backward directions (horizontal direction).

As shown in FIG. 2, the main unit 30 includes a printed circuit board (not shown in the drawings), and a chassis 31 provided on the printed circuit board. Further, as was described above, the main unit 30 is housed in the casing 20 made from a thin metal plate.

Further, the printed circuit board (not shown in the drawings) includes an interface connector for making a connection with a computer body or the like, various IC components such as a microprocessor, memories, a motor driver and the like, and various electrical or electronic components such as resistors, capacitors, switches and the like. These components make it possible to control the operations of a spindle motor, a loading motor, a sled motor, an optical pick-up and the like as will be described below.

Further, a front bezel 46 is attached to the front portion of the casing 20.

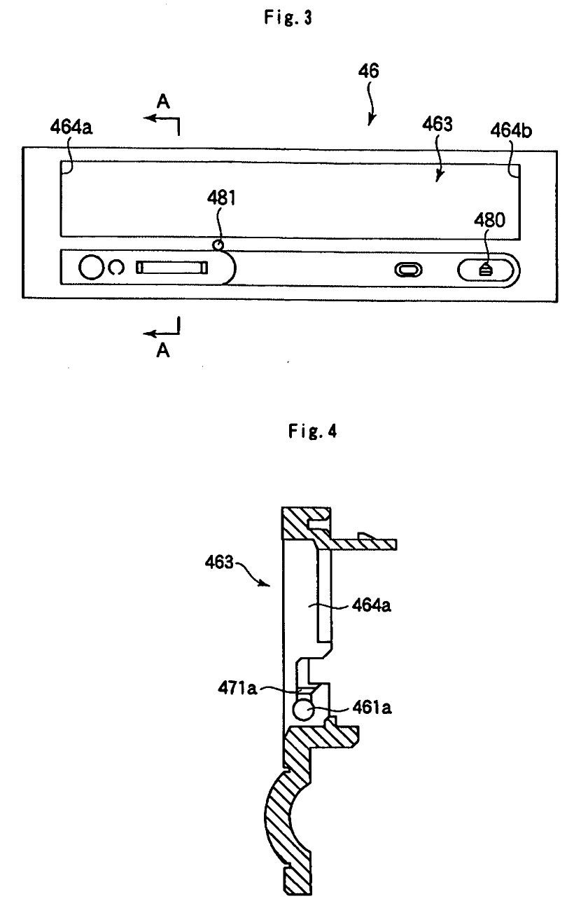

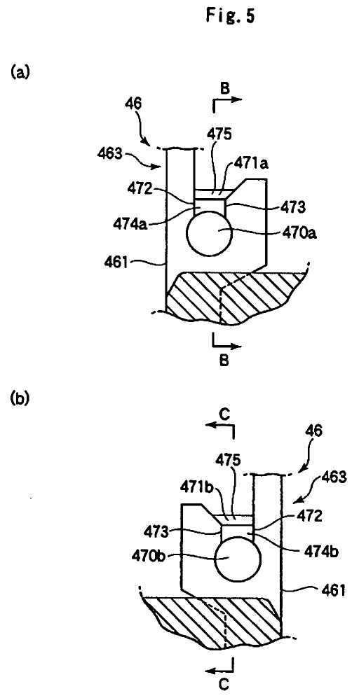

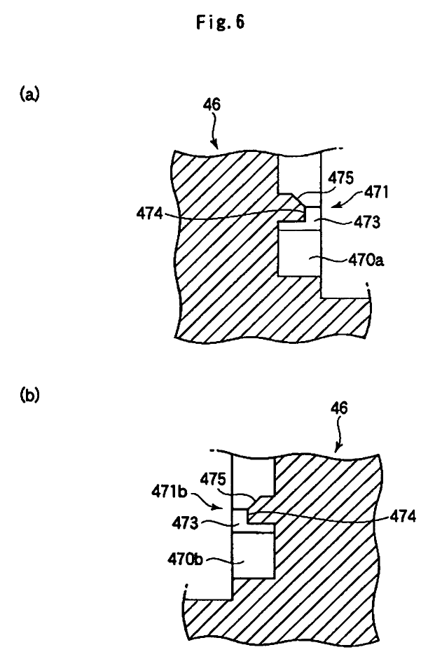

FIG. 3 is a front view of the front bezel 46, FIG. 4 is a cross-sectional view taken along the line A-A of FIG. 3, FIG. 5(a) is an enlarged view of a concave portion 470a and a guide groove portion 471a, and FIG. 5(b) is an enlarged view of a concave portion 470b and a guide groove portion 471b. Further, FIG. 6(a) is a cross-sectional view taken along the line B-B in FIG. 5(a), and FIG. 6(b) is a cross-sectional view taken along the line C-C in FIG. 5(b).

The front bezel 46 is formed from a resin or the like, and as shown in FIG. 3 and FIG. 4, the upper portion thereof is formed with an opening 463 to enable the disc tray 51 to be ejected from and inserted into the main unit 30. Further, the lower portion of the front bezel 46 is formed with an eject button 480 of the disc tray 51, and a jig insertion hole 481 through which a slender rod-shaped jig is inserted when an emergency ejection mechanism described below is used.

Further, the opening 463 of the front bezel 46 is provided with a shutter 49 having substantially the same shape as the opening 463 to close the opening 463 in the case where the disc tray 51 is housed inside the main unit 30.

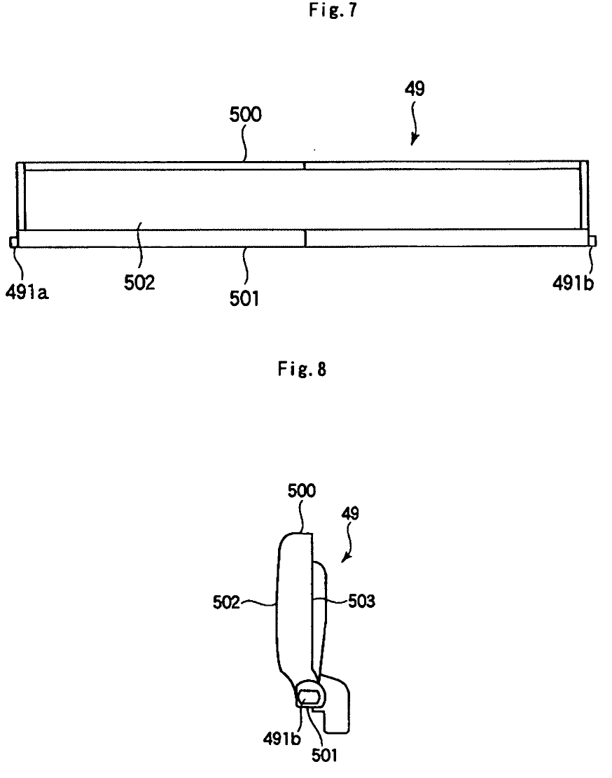

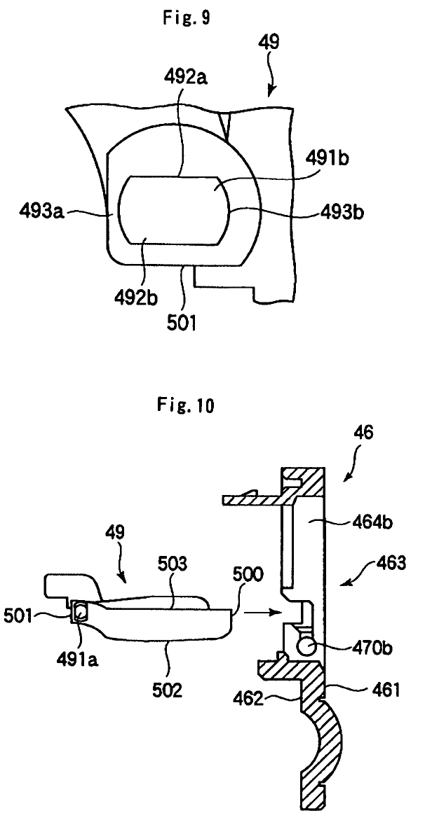

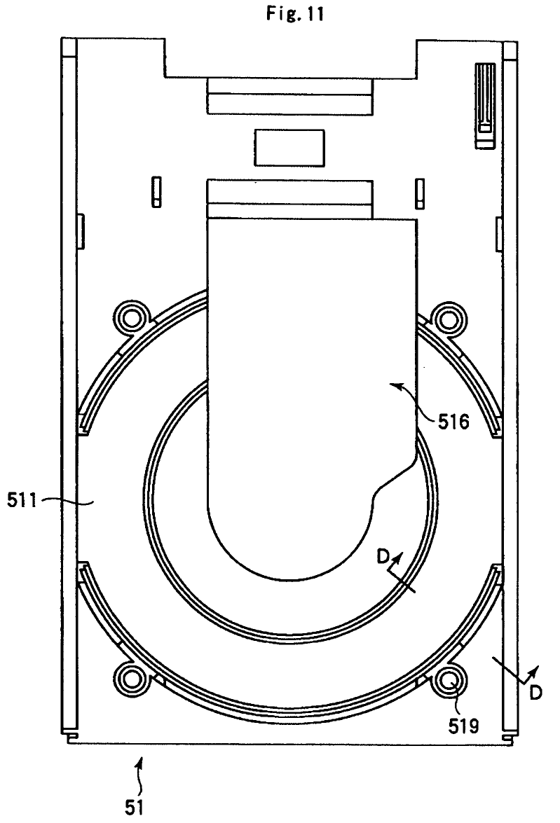

FIGS. 7 and 8 are respectively a front view and a right side view of the shutter 49 of the disc drive according to the present invention, and FIG. 9 is an enlarged view of a shank of the shutter 49. Further, FIG. 10 is an explanatory view showing the positional relationship when the shutter 49 is mounted to the front bezel 46.

As shown in FIG. 7, the shutter 49 is formed into a roughly plate-like shape which is long in the left and right directions. Further, in order to mount the shutter 49 to the front bezel 46, shaft portions 491a, 491b are provided on both end portions in the longitudinal direction of the shutter 49, namely, on lower portions of both left and right side surfaces to form the rotation center of the shutter 49 when the shutter 49 is opened and closed.

Further, the shaft portions 491a and 491b are positioned below the opening 463, and in this way when the shutter 49 is mounted to the front bezel 46, the shutter 49 will rotate around a center near the lower portion of the opening 463 provided in the front bezel 46.

Further, as shown in FIG. 9, the peripheral surfaces of each of the shaft portions 491a and 491b are formed with a pair of mutually parallel plane portions 492a, 492b and circular portions 493a, 493b which connect corresponding end portions of the plane portions 492a, 492b, so that the cross section of each of the shaft portions 491a and 491b which is vertical to the axial direction thereof forms a roughly oval shape.

Further, in the present embodiment, the plane portions 492a and 492b form a parallel position relationship with a top surface 500 and a bottom surface 501 of the shutter 49, respectively. The reason for this arrangement will be explained later.

Further, the spacing between the plane portions 492a and 492b is formed to be roughly the same as the width of the guide grooves 471a and 471b (described below) provided in the front bezel 46.

Further, as shown in FIG. 4 and FIG. 5, the front bezel 46 are formed with concave portions 470a and 470b for receiving the shaft portions 491a and 491b of the shutter 49, respectively, so that the shutter 49 is rotatably mounted to the front bezel 46.

As shown in FIGS. 3 and 4, the concave portions 470a and 470b are provided in left and right edge portions 464a and 464b of the opening 463 of the front bezel 46, respectively, and as shown in FIG. 6, they are formed into rough cylindrical concavities having the same center axis as the shaft portions 491a and 491b provided on the shutter 49, respectively.

Further, guide grooves 471a and 471b are provided above the concave portions 470a and 470b in order to guide the shaft portions 491a and 491b provided on both the left and right ends of the shutter 49 to the concave portions 470a and 470b, respectively, when the shutter 49 is mounted to the front bezel 46.

As shown in FIGS. 5(a) and 5(b), the guide grooves 471a and 471b extend roughly upward direction of the concave portions 470a and 470b, respectively. Further, each of the guide grooves 471a and 471b is defined by the three surfaces comprised of a front surface portion 472, a rear surface portion 473 which is opposed to the front surface portion 472 and a connecting surface portion 474. The spacing between the front surface portion 472 and the rear surface portion 473 is formed to be roughly the same as the distance between the plane portions 492a and 492b of each of the shaft portions 491a and 491b.

Further, as shown in FIGS. 6(a) and 6(b), the upper portions of the respective connecting surface portions 474a and 474b of the guide grooves 471a and 471b form inclined planes 475 which are inclined so that the respective top ends are positioned outside the left and right directions, and the bottom ends are positioned inside the left and right directions, respectively. Then, the shaft portions 491a and 491b of the shutter 49 inserted from the top side of the guide grooves 471a and 471b are guided to the connecting surfaces 474a and 474b by the inclined surfaces 475, 475 and then engage with the concave portions 470a and 470b, respectively, and this prevents the shaft portions 491a and 491b from being disengaged from the concave portions 470a and 470b after the shaft portions 491a and 491b are mounted in the concave portions 470a and 470b.

Next, the process for mounting the shutter 49 to the front bezel 46 will be described below.

First, as shown in FIG. 10, the shutter 49 is inserted into the opening 463 of the front bezel 46 such that the top surface 500 of the shutter 49 is positioned at the side of a front surface 461 of the front bezel 46, and the bottom surface 501 of the shutter 49 is positioned at the side of a rear surface 462 of the front bezel 46. Then, the shutter 49 is moved horizontally in the direction of the arrow shown in FIG. 10 so that the shaft portions 491a and 491b of the shutter 49 are positioned above the guide groove portions 471a and 471b of the front bezel 46, respectively.

In this way, a roughly vertical relationship is established between the front surface 461 of the front bezel 46 and the front surface 502 of the shutter 49. This forms a parallel position relationship between the front surface portion 472 and the rear surface portion 473 of the guide grooves 471a and 471b provided on the front bezel 46, and the plane portions 492a and 492b provided on the shaft portions 491a and 491b of the shutter 49. This also makes it possible to insert the shaft portions 491a and 491b into the concave portions 471a and 471b via the guide grooves 471a and 471b, respectively.

Next, by applying a force to the shutter 49 in the direction downward from the top, the shutter 49 is mounted to the front bezel 46. Namely, the roughly middle part in the longitudinal direction of the rear surface of the shutter 49 is pushed to slightly deform the shutter 49. This narrows the spacing between the end surfaces of the shaft portions 491a and 491b to make it possible to engage the shaft portions 491a and 491b of the shutter 49 with the concave portions 470a and 470b of the front bezel 46, respectively, whereby the shutter 49 is mounted to the front bezel 46.

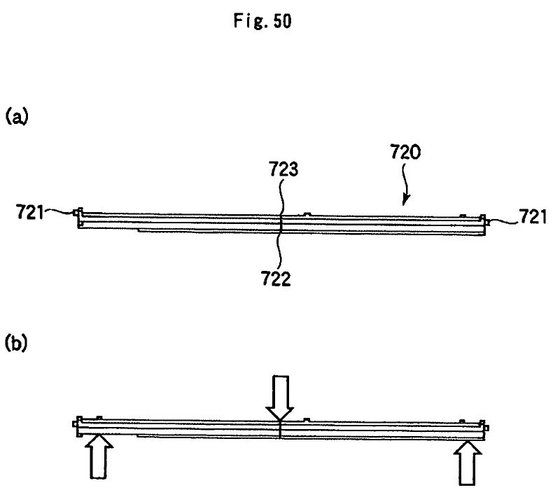

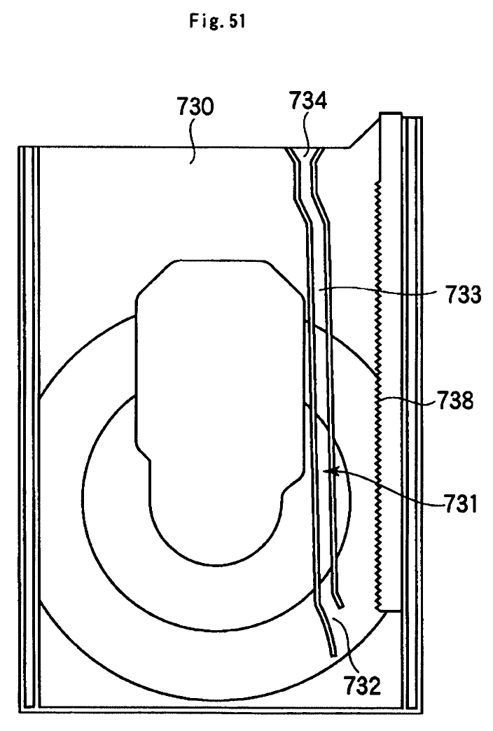

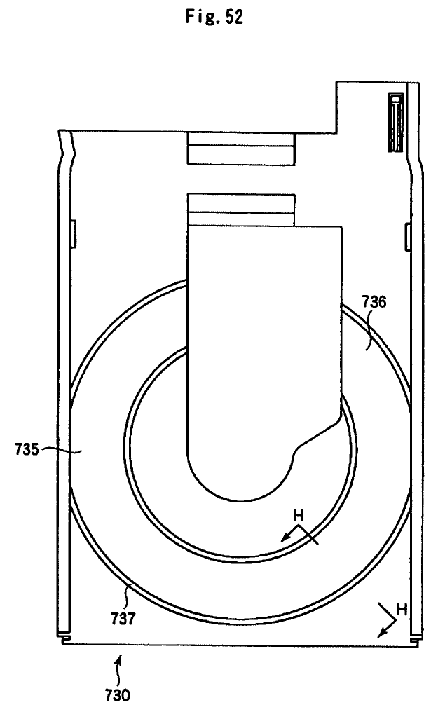

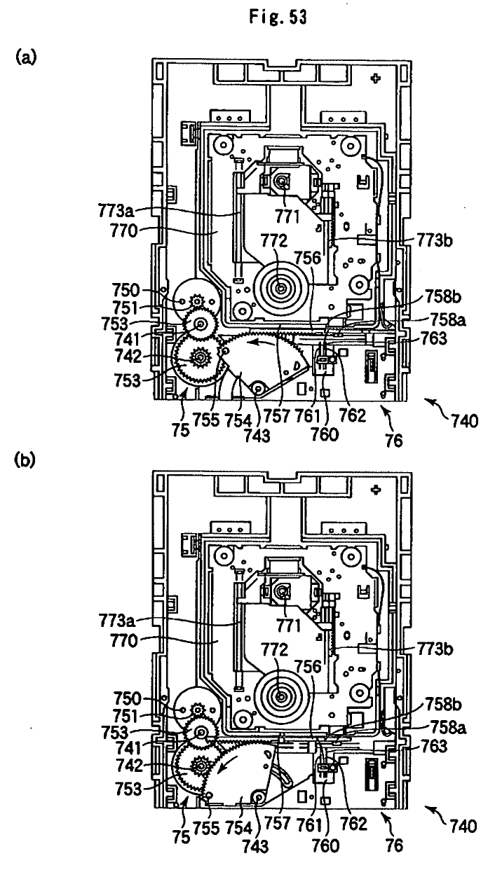

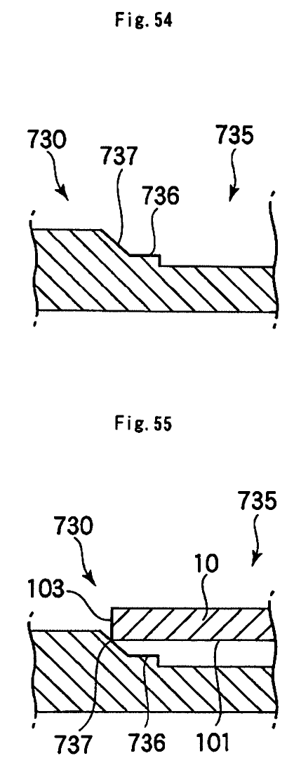

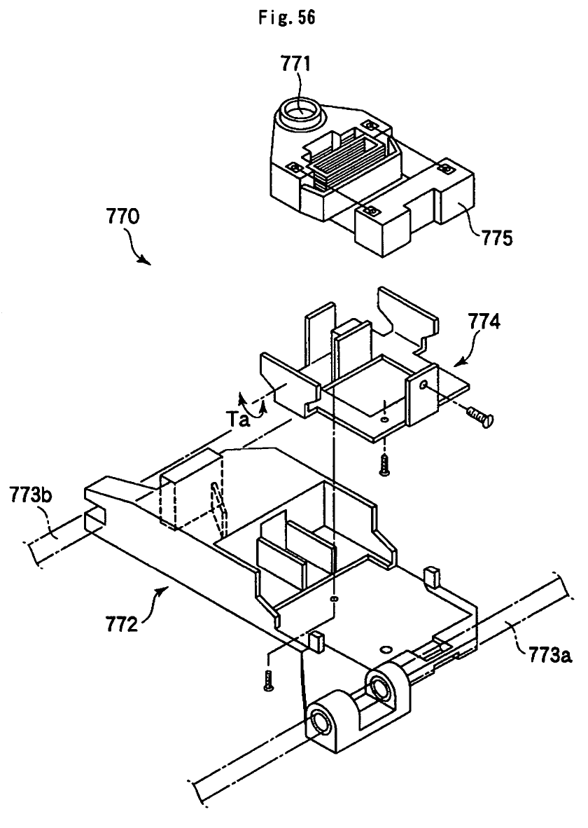

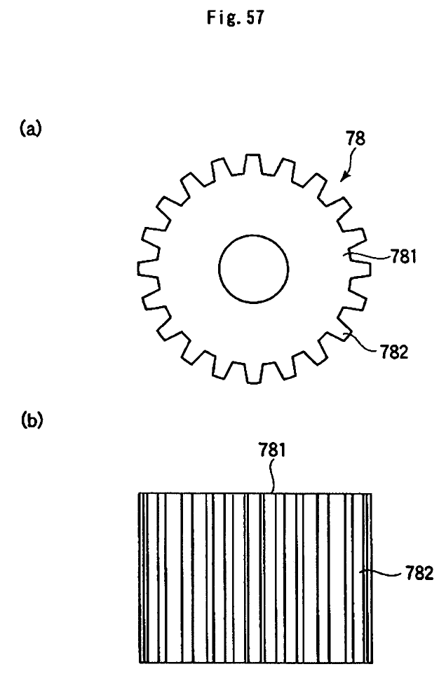

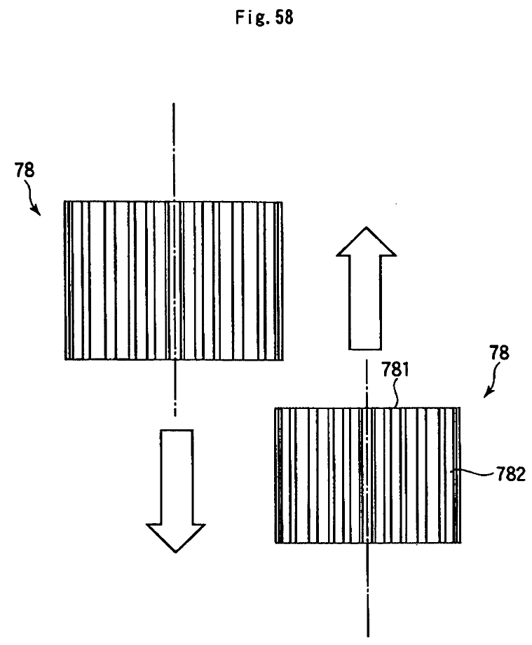

In this way, in accordance with the shutter mounting structure of the present embodiment, when the shutter 49 is mounted to the front bezel 46, such mounting can be completed merely by pushing only one location roughly in the middle of the rear surface 503 of the shutter 49. For this reason, as compared with the prior art shutter mounting structure in which pushing is carried out at three locations including roughly the middle of a rear surface 723 of a shutter 720 and the vicinity of both end portions of a front surface 722 of the shutter 720 in order to bend the shutter 720 for mounting into the front bezel (FIG. 50), the mounting structure of the present embodiment makes it possible to carry out a much easier mounting operation.

Further, as described above, in the present embodiment, the guide grooves 471a and 471b are provided above the concave portions 470a and 470b, respectively. Further, the plane portions 492a and 492b provided on the shaft portions 491a and 491b are formed so as to be roughly parallel to the top surface 500 and the bottom surface 501 of the shutter 49. By using such a structure, it is virtually impossible for the shutter 49 to be removed from the front bezel 46 even in the case where the user of the disc drive 1 mistakenly pulls the shutter 49.

Further, in the present embodiment, the front bezel 46 was used as a support member for the shutter 49, but the present invention is not limited to this structure, and it is also possible to use a part of the chassis 31 described below as a support member for the shutter 49. Further, the positions of the guide grooves 471a and 471b are not limited to the arrangement of the present embodiment in which they are provided above the concave portions 470a and 470b, and it is also possible to provide the guide groove portions 471a and 471b below the concave portions 470a and 470b.

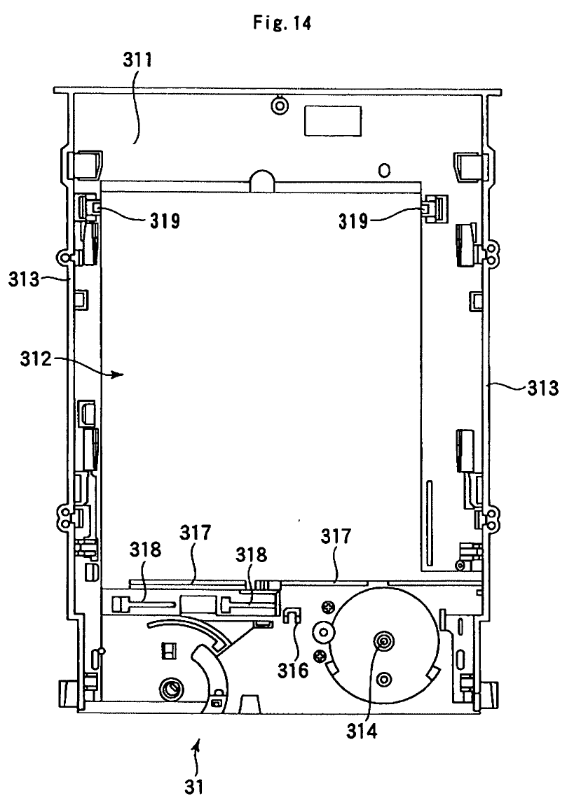

As shown in FIG. 2 and FIG. 14, the main unit 30 housed in the casing 20 includes a chassis 31 formed from a hard resin or the like. The chassis 31 includes a bottom portion 311 having a roughly rectangular opening 312 formed therein, and a wall portion 313 arranged in a roughly U-shape along the left, right and back edge portions of the bottom portion 311.

Further, the front side of the chassis 31 is not provided with any wall portion in order to form an open state. Therefore, when the main unit 30 is put into the casing 20, the open portion of the chassis 31 is aligned with the opening 463 of the front bezel 46 mounted to the casing 20, and this makes it possible for the disc tray 51 to be ejected and inserted through the opening 463. A detailed description of the chassis 31 is given later.

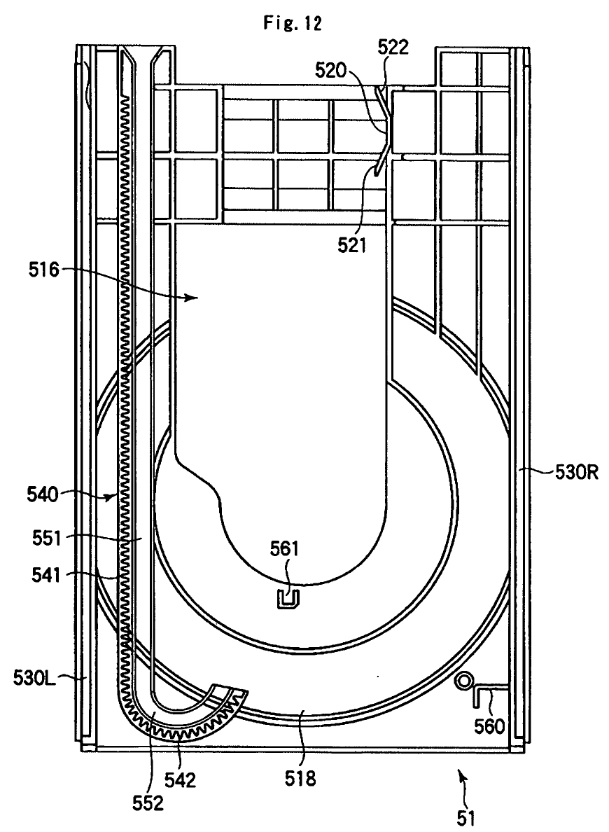

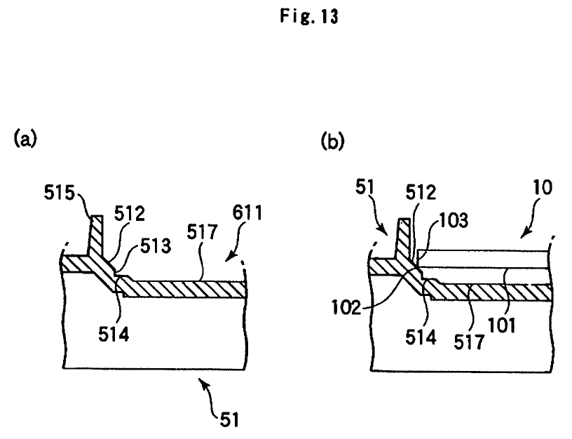

FIGS. 11 and 12 are respectively top and bottom views of the disc tray of the disc drive according to the present invention, and FIG. 13 is a cross-sectional view taken along the line D-D in FIG. 11.

As shown in FIG. 11, the disc tray 51 includes a shallow concave disc holding portion 511. Then, when a disc 10 is placed on the disc holding portion 511 of the disc tray 51, the disc 10 is conveyed in a state where the disc 10 is strictly positioned at a prescribed position of the disc tray 51 to a disc loading position (disc reproducing (playback) position).

As shown in FIG. 13, the disc holding portion 511 includes a guiding slant surface 512 which guides an outer peripheral lower edge 102 of the disc 10 when the disc 10 is placed on the disc tray 51, and an inner wall portion 513 formed continuous with the inner peripheral edge of the guiding slant surface 512 roughly parallel to the thickness direction of the disc 10 so as to face an outer peripheral surface 103 of the disc 10 when the disc 10 is placed on the disc tray 51.

Further, a disc support surface 514 which makes contact with a bottom surface 101 of the disc 10 in order to support the disc 10 is formed continuous with the lower edge of the inner wall portion 513 so as to form a roughly right angle with respect to the inner wall portion 513. Further, disc disengagement prevention portions or members 515 are provided at the upper end portion of the guiding slant surface 512 to prevent such a trouble that the disc 10 is disengaged from (displaced out of) the disc holding portion 511 of the disc tray 51 and such a disengaged disc 10 remains inside the main unit 30 or the like when the disc tray 51 is moved or the disc drive 1 is arranged vertically or the like. Even though an effect can be achieved by providing one disc disengagement prevention portion or member 515 at one location of the upper end portion of the guiding slant surface 512, in the present embodiment, four disc disengagement prevention portions 515 are provided at four locations in order to prevent disengagement of the disc in the case where the disc drive 1 is arranged vertically, as shown in FIG. 11. Further, the portions indicated by the reference number 519 in FIG. 11 are mounting holes for mounting abutment members (not shown in the drawings) for preventing the disc from falling out when the disc drive 1 is arranged vertically.

The guiding slant surface 512, the inner wall portion 513, the disc support surface 514 and the disc disengagement prevention portions 515 are arranged in a roughly concentric state with respect to the center of rotation of the disc 10 placed on the disc holding portion 511, and are positioned near the peripheral portion of the disc 10.

In more specific detail, when the disc 10 is placed on the disc holding portion 511, in the case where the disc 10 is at a position shifted slightly from the inner wall portion 513, namely, in the case where the outer peripheral edge 102 of the disc 10 makes contact with the guiding slant surface 512, the bottom surface 101 of the disc 10 is guided downward along the guiding slant surface 512, whereby the bottom surface 101 of the disc 10 is reliably guided to the disc support surface 514.

On the other hand, when the disc tray 51 is moved between a disc ejection position and a disc loading position (reproducing position) with the disc 10 held in the disc holding portion 511, the inner wall portion 513 has the function of restricting rattling of the disc 10 within the disc holding portion 511.

In more specific detail, when the disc tray 51 is moved between the disc ejection position and the disc loading position, the disc 10 held in the disc holding portion 511 will move slightly inside the disc holding portion 511 due to the inertial force of the disc 10. At such time, the inner wall portion 513 holds the outer peripheral surface 103 of the disc 10, and the movement of the disc 10 is restricted at the position of the inner wall portion 503.

At this time, if we assume that the inner wall portion 513 doesn't have the positional relationship of being roughly parallel with the outer peripheral surface 103 of the disc 10 as described above for the disc tray 51 of the present embodiment, and is inclined like the guiding slant surface 737 of the disc tray 730 of the prior art disc drive 70 shown in FIG. 55, the bottom surface of the disc 10 will be guided upward along the guiding slant surface 737 due to the movement of the disc tray 730. This may cause, depending on the cases, the disc 10 to be disengaged and then come away from the disc holding portion 735 of the disc tray 730. If such an accident is happened, there is a risk that the recording surface of the disc 10 is damaged. Further, there is a risk that the disc is being left inside the disc drive, thereby make it impossible to eject the disc 10.

However, as described above, the inner wall portion 513 of the disc holding portion 511 of the present embodiment has the positional relationship of being parallel with the outer peripheral surface 103 of the disc 10 supported by the disc support surface 514. Therefore, in the case where the disc 10 is moved by the sliding movement of the disc tray 51, there is contact near the upper edge of the outer peripheral surface 103 of the disc 10 in addition to the contact near the lower edge thereof. This makes it possible to restrict the movement of the disc 10. For this reason, according to the disc tray 51 of the present embodiment, it is possible to prevent the problem that occurs with the disc tray 730 used in the prior art disc drive 70, namely, the disengagement of the disc 10 from the disc tray 730 caused by the upward movement of the outer peripheral lower edge 102 of the disc 10 along the guiding slant surface 737 due to the movement of the disc 10 caused by the sliding movement of the disc tray 730.

Further, as shown in FIG. 11, the disc support surface 514 is provided roughly concentric with the center of rotation of the disc 10, and when the disc 10 is placed thereon, contact is made only with the non-recording portion positioned near the outer periphery of the disc 10. In this way, it is possible to prevent the recording surface of the disc 10 from being damaged due to the contact of the bottom surface 101 of the disc 10 with the bottom surface 517 of the disc holding portion 511.

Further, as shown in FIG. 11 and FIG. 12, a rough rectangular opening 516 is formed in the disc tray 51 from roughly the center of the disc holding portion toward the rear side thereof. As will be described later, a turntable 321 is raised through the opening 516, and a scan by an optical pick-up 351 is carried out.

Further, as shown in FIG. 12, a slider movement restricting rib 520 for restricting the movement of a slider 680 described below is protrudingly provided at the rear side of the opening 516 on the bottom surface 518 of the disc tray 51. The slider movement restricting rib 520 includes a front guiding slant surface 521 and a rear guiding slant surface 522 for guiding the slider 680 described below. A detailed description of the function of the slider movement restricting rib 520 will be given later.

Further, as shown in FIG. 12, guide grooves 530L, 530R which engage respectively with guide members 323 (see FIG. 14) provided on the left and right sides of the chassis 31 are formed in the left and right sides of the bottom surface 518 of the disc tray 51.

Further, the bottom surface 518 of the disc tray 51 is also provided with a rack gear 540 which includes a linear rack gear 541 which extends in the longitudinal direction of the disc tray 51 and an arc-shaped rack gear 542 having an angle of approximately 180 degrees which is formed continuous with the front end portion (front side of the disc tray 51) of the linear rack gear 541, and a guide groove 550 which is provided parallel to the rack gear 540 and which includes a linear guide groove 551 provided along the linear rack gear 541 and an arc-shaped guide groove 552 provided along the arc-shaped rack gear 542.

Furthermore, as shown in FIG. 12, the side of the bottom surface 518 of the disc tray 51 opposite the front side where the arc-shaped rack gear 542 is located is provided with a rib 561 for an emergency ejection mechanism which is used when the disc tray 51 is pushed forward by an emergency ejection mechanism described later.

A disc tray movement restricting rib (protruding portion) which is indicated by the reference numeral 561 in FIG. 12 is provided for restricting the movement of the disc tray 51 in the horizontal direction (longitudinal direction) by engaging with a disc tray lock portion 316 (described below) formed in the chassis 31 via a first protrusion 582 of a cam member 572.

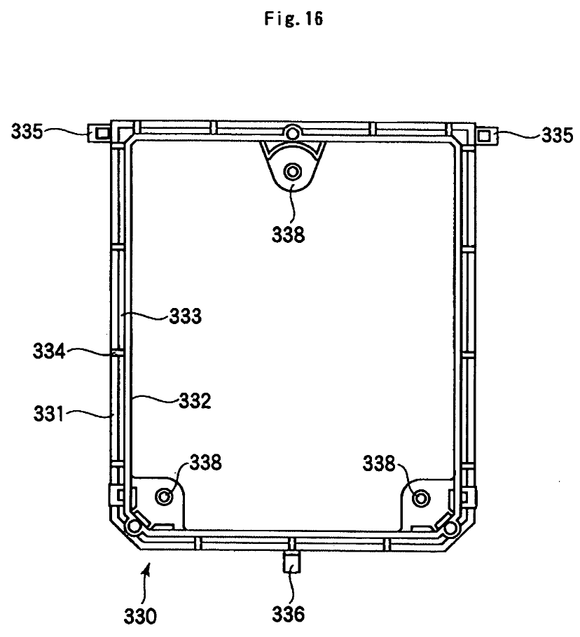

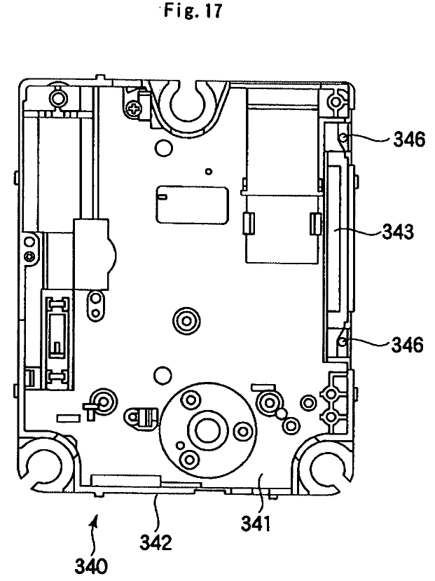

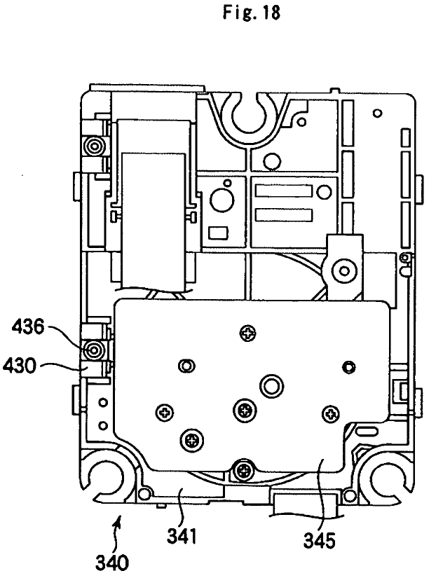

FIG. 14 is a top view of the chassis 31 of the disc drive according to the present invention. Further, FIG. 16 is a top view of a base frame of a mechanism unit of the disc drive according to the present invention, and FIGS. 17 and 18 are respectively a top view and a bottom view of a holding member of such mechanism unit.

As shown in FIG. 2, the chassis 31 is provided with a mechanism unit 32 which is equipped with a turntable 321 for supporting the disc 10, an optical pick-up 351 for carrying out reproducing or recording and reproducing of the disc 10, and the like.

The mechanism unit 32 is arranged so as to be housed inside the rough rectangular opening 312 formed in the bottom portion 311 of the chassis 31 shown in FIG. 14, and is supported at the rear portion thereof so as to be capable of pivotal movement with respect to the chassis 31. As a result, the front portion of the mechanism unit 32 is capable of being displaced between a raised position (upper position) which supports the disc 10 on the turntable 321 and a lowered position (lower position) which is lower than the raised position.

In more specific detail, as shown in FIG. 2, the mechanism unit 32 includes a base frame 330 preferably formed by a hard resin, and a holding member 340 which is supported with respect to the base frame 330 via an elastic members (insulators) 450.

The base frame 330 shown in FIG. 16 is formed as a rough square shaped frame which includes a front portion and a rear portion. The base frame 330 includes a rectangular outer frame 331, a rough rectangular inner frame 332 positioned inside the outer frame 331 and formed so as to have a smaller circumference than the outer frame 331 and C-shaped corner portions, a connecting portion 333 which integrally connects the outer frame 331 and the inner frame 332 at a roughly intermediate position in the height direction, and a plurality of reinforcing portions 334 integrally formed with the top of the connecting portion 333 at prescribed spacings over the entire circumference, whereby the alternating positioning of the reinforcing portions 334 and the connecting portion 333 between the outer frame 331 and the inner frame 332 forms a so-called ladder frame.

As shown in FIG. 16, protruding shafts 335, 355 which function as pivotal support portions with respect to the chassis 31 of the mechanism unit 32 are formed at both the left and right side portions of the rear portion of the base frame 330 (i.e., at the rear of the main unit 30), respectively. These shafts 335 are inserted respectively through shaft holes 319, 319 formed on the chassis 31 shown in FIG. 14. In this way, the mechanism unit 32 is pivotally supported so that the rear portion thereof is capable of pivotal movement with respect to the chassis 31. Further, when the mechanism unit 32 (base frame 330) is pivoted around the shafts 335, the front portion of the mechanism unit 32 is displaced upward and downward between a raised position and a lowered position with respect to the chassis 31.

As shown in FIG. 16, one protruding guide pin 336 is provided at the front portion of the base frame 330. The guide pin 336 engages with a cam groove 591 of a cam member 572 of a cam mechanism 571 described later, whereby the front portion of the base frame 330 is guided upward and downward by the displacement of the cam member 572.

As shown in FIG. 2, a prescribed gap 337 is formed between the base frame 330 having the above structure and the chassis 31 defining the opening 312. The gap 337 is formed over roughly the entire circumference of the base frame 330, and the width thereof is established so that the pivotal movement of the base frame 330 is not hindered even by the maximum deformation of the chassis 31.

Further, a tab 338 is provided in roughly the middle of the rear portion of the inner frame portion 332 of the base frame 330, and tabs 338, 338 are provided at the left and right corners of the front portion of the inner frame 332. These tabs 338 are provided in order to support the holding member 340.

As shown in FIG. 17, the holding member 340 is constructed from a rough rectangular bottom portion 341 and a wall portion 342 formed around the periphery thereof. As shown in FIG. 2, the wall portion 342 is formed to have a smaller circumference than the inner frame 332 of the base frame 330 so as to be housed inside the inner frame 332 of the base frame 330 via a prescribed gap 344.

The holding member 340 is supported on the base frame 330 via the elastic members (insulators) 450 respectively provided on the three tabs 338 of the base frame 330. Namely, the holding member 340 is supported on the base frame 330 via the elastic members 450 at three locations which roughly form an isosceles triangle. In this way, the vibration generated by the rotation of the disc 10 and the spindle motor is absorbed by the elastic members 450, thereby preventing the vibration from being transmitted to the chassis 31.

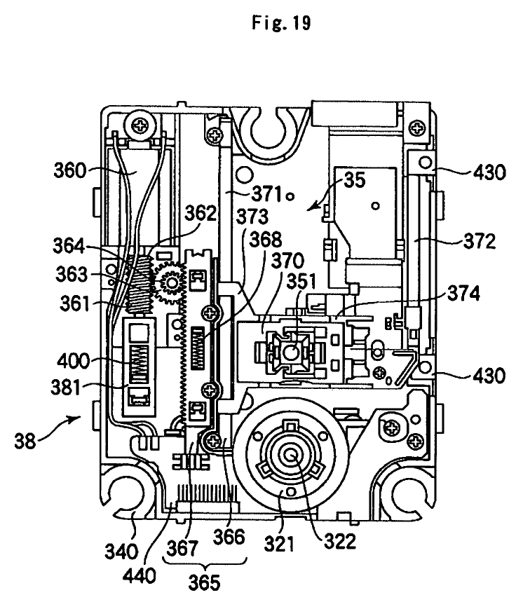

Further, as shown in FIG. 19, the holding member 340 is provided with a spindle motor (not shown in the drawings) for rotating the turntable 321 fixed to the rotation shaft 322 of the spindle motor, the optical pick-up 351 for reading out data from the disc 10 or writing data onto the disc 10, and an optical pick-up moving mechanism 35 which functions as a sliding mechanism for moving the optical pick-up 351 in the radial direction of the disc 10.

The spindle motor is mounted to a substrate 440 fixed to the holding member 340. Further, as shown in FIGS. 17 and 18, the right front portion, the right rear portion and roughly the middle of the rear surface of the holding member 340 are provided with weights 345 to suppress the vibration of the holding member 340 caused by the rotation of the disc 10 and the spindle motor by increasing the weight of the holding member 340.

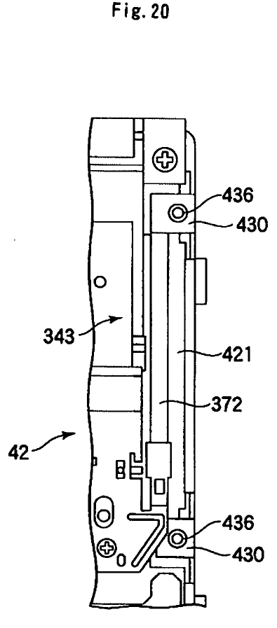

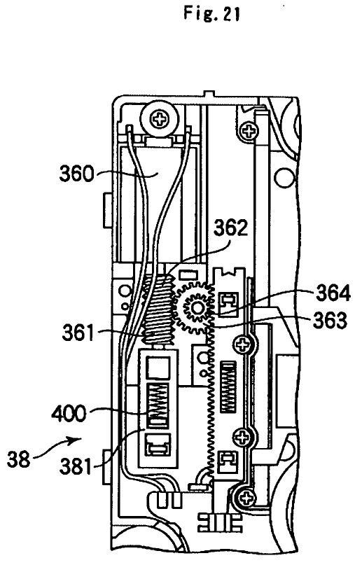

FIG. 19 is a top view of the optical pick-up moving mechanism 35 of the disc drive according to the present invention. Further, FIG. 20 is an enlarged view of an engagement portion provided at the right side of the optical pick-up 351.

As shown in detail in FIG. 19, the optical pick-up moving mechanism 35 is constructed from a sled motor 360 capable of forward/reverse rotation and equipped with a rotation shaft 362 which includes a worm (lead screw) 361 having teeth in the shape of a screw, a worm wheel 363 which meshes with the worm 361, a small diameter pinion gear 364 integrally formed on the same shaft on the top surface of the worm wheel 363, a rack gear 365 which meshes with the pinion gear 364, a pick-up base 370 which holds the optical pick-up 351 and which is fixed to the rack gear 365, and a first guide rod 371 and a second guide rod 372 which guide the direction of movement of the pick-up base 370.

The worm 361, the worm wheel 363, the pinion gear 364 and the rack gear 365 are all formed from plastic. As shown in FIG. 19, both ends of the rack gear 365 are supported by two bearing portions 373, 373 provided on the pick-up base 370.

Further, as shown in FIG. 19, the rack gear 365 is constructed from an upper rack gear 366 and a lower rack gear 367 formed to have the same size teeth, and the upper rack gear 366 is mounted so as to be capable of moving in the longitudinal direction with respect to the lower rack gear 367. Furthermore, as shown in FIG. 19, the upper rack gear 366 is biased toward the front by a coil spring 368 which expands and contracts in the longitudinal direction, whereby the teeth provided on the upper rack gear 366 and the teeth provided on the lower rack gear 367 form a positional relationship in which they are shifted slightly in the longitudinal direction. According to this structure, when the rack gear 365 meshes with the pinion gear 364, the upper rack gear 366 and the lower rack gear 367 reliably make contact with a rear tooth surface and a front tooth surface of a tooth of the pinion gear 364, respectively, regardless of the meshed state between the rack gear 365 and the pinion gear 364. This prevents rattling from occurring between the rack gear 365 and the pinion gear 364.

Further, as shown in FIG. 19, the worm 361, the first guide rod 371 and the second guide rod 372 are all arranged in the longitudinal direction of the disc drive 1 so as to be parallel with each other in the direction of the movement of the pick-up base 370. Further, the first guide rod 371 and the second guide rod 372 are respectively provided near the right side and the left side of the pick-up base 370, respectively.

Further, this combination of the worm 361, the worm wheel 363, the pinion gear 364 and the rack gear 365 forms a reduction gear mechanism in the optical pick-up moving mechanism 35, wherein the rotation of the sled motor 360 is converted into linear motion of the optical pick-up 351, and by rotating the sled motor 360 in the forward and reverse directions, it is possible to move the optical pick-up 351 reciprocally in the radial direction of the disc 10.

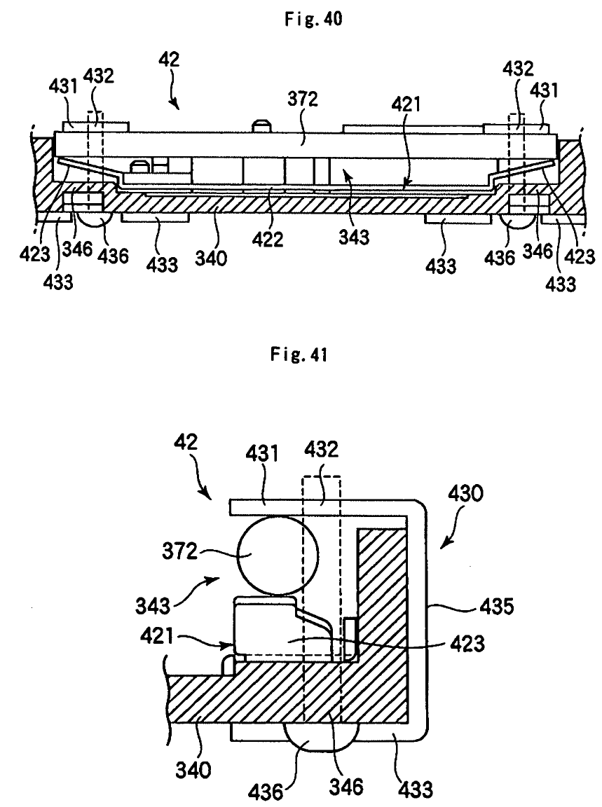

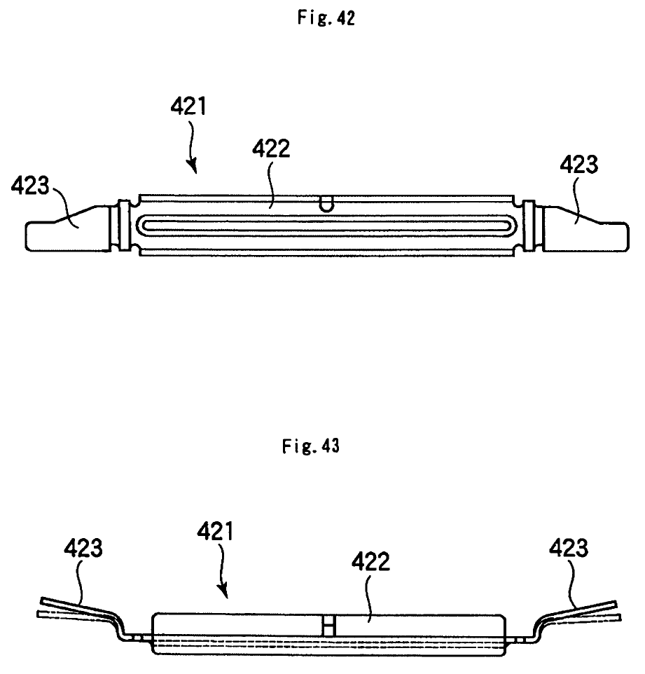

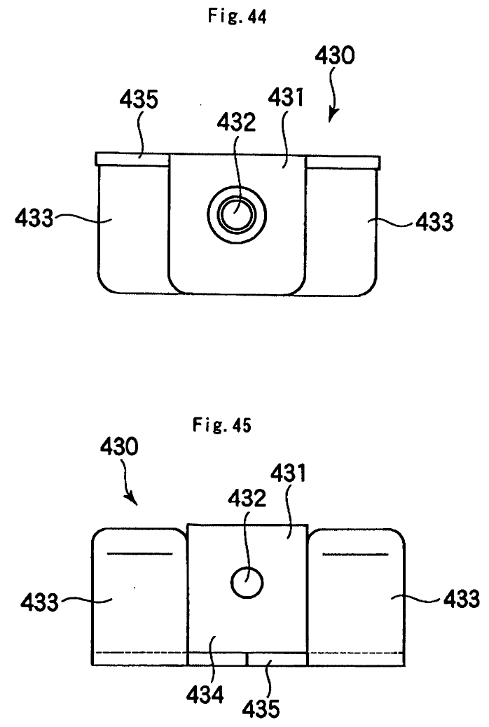

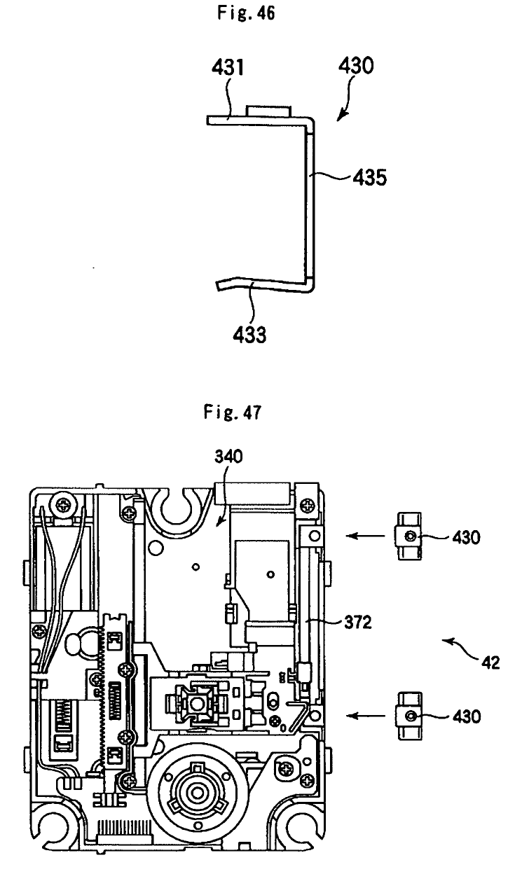

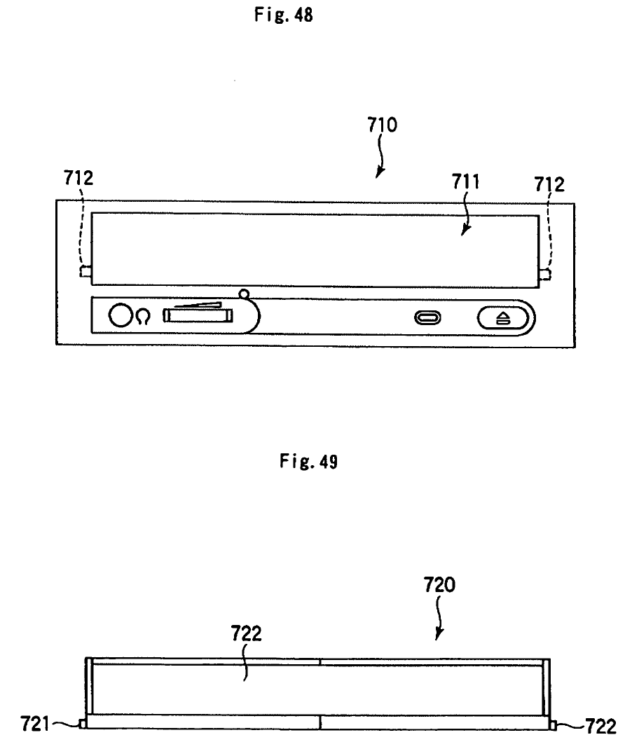

FIGS. 40 and 41 are respectively a right side view and a cross-sectional view showing the essential portion of a skew adjustment mechanism of the optical pick-up of the disc drive according to the present invention. Further, FIG. 42 and FIG. 43 are respectively a top view and a side view of a guide rod pushing spring of the skew adjustment mechanism, and FIGS. 44 through 46 are respectively a top view, a bottom view and a side view of a guide rod holding member of the skew adjustment mechanism. Further, FIG. 47 is an explanatory view showing the process for mounting the guide rod holding members of the skew adjustment mechanism of the disc drive according to the present invention to the holding member of the mechanism unit.

A description of the optical pick-up 351 is given below with reference to FIG. 19 and FIGS. 40 through 46.

As shown in FIG. 19, the optical pick-up 351 is mounted on the pick-up base 370 which is slidably coupled to the first guide rod 371 in the same manner as the optical pick-up 771 used in the prior art disc drive 70 described above. Further, in the same manner as for the prior art disc drive 70, the pick-up base 370 is provided with an actuator base, a damper base and the like.

As shown in FIG. 19, the pick-up base 370 is constructed from the bearing portions 373 which include a pair of bearings provided with a spacing for inserting the first guide rod 371, and a body portion 374 which is integrally formed with the bearing portions 373 and extends to roughly the left end of the holding member 340 at a right angle with respect to the first guide rod 371. The bearing portions 373 and the body portion 374 are integrally formed from a die-cast metal or the like.

Further, although not shown in the drawings, in the same manner as the prior art described above, the body portion 374 is equipped with a laser diode (LD) which emits a laser beam, a beam splitter which directs the beam from the laser diode to a mirror for reflection, a mirror which reflects the beam from the beam splitter toward an objective lens, and a photodiode which receives the beam reflected from the disc via the objective lens, the mirror and the beam splitter, and generates electrical signals in response to changes in the intensity of the received beam.

Further, the end portion which is opposite to the end portion at the side of the first guide rod 371 of the pick-up base 370, that is, the end portion at the side of the second guide rod 372 is provided with an engagement portion having a rough U-shaped cross-section which supports the left end portion of the pick-up base 370, and which includes two sliding surfaces which slidably make contact with the top and bottom of the peripheral surface of the second guide rod 372.

A description of the skew adjustment mechanism of the optical pick-up 351 provided in the pick-up base 370 is given below.

As described above, the right end portion and the left end portion of the pick-up base 370 are supported on the first guide rod 371 and the second guide rod 372, respectively.

A skew adjustment mechanism 42 in the disc drive of the present invention is constructed by fixing the first guide rod 371 to the holding member 340, and arranging the second guide rod 372 to be movable up and down with respect to the holding member 340, wherein the adjustment of the tangential skew of the optical pick-up 351 is carried out by pivotally displacing the right end portion of the pick-up base 370 around the central axis of the first guide rod 371.

Namely, as shown in FIGS. 41 and 42, the skew adjustment mechanism 42 includes a mounting portion 343 which is provided on the holding member 340 and forms a base for supporting the skew adjustment mechanism 42, a guide rod pushing spring 421 provided on the mounting portion 343 to push the bottom of the circumferential surface of the second guide rod 372 upwardly, guide rod holding members 430 which make contact with the top of the circumferential surface of the second guide rod 372, and a screw 436 which is screwed into the guide rod holding members 430.

The mounting portion 343 is provided along the right side of the holding member 340, and includes an insertion hole 346 for inserting the screw 436 in the left and right ends thereof.

The guide rod pushing spring 421 is formed from a metal plate member, and as shown in FIGS. 42 and 43, the guide rod pushing spring 421 is constructed from a support plate portion 422 and spring plate portions 423 which extend upward at an inclined form from both longitudinal ends of the support plate portion 422, respectively.

As shown in FIGS. 44 through 46, the guide rod holding member 430 is constructed from an upper plate 431 which includes a screw hole 432 into which the screw 436 is screwed, a lower plate 433 which includes a mounting hole which faces the upper plate 431 and through which a tool is inserted when mounting the screw 436, and a connecting plate 435 which connects the upper plate 431 and the lower plate 433, and these form a member having a rough U-shaped vertical cross section.

The process of positioning the second guide rod 372 on the holding member 340 using these members and parts is described below.

First, the support plate portion 422 of the guide rod pushing spring 421 is placed in the mounting portion 343, and the second guide rod 372 is placed on top of the two spring plate portions 423 of the guide rod pushing spring 421. Next, the guide rod holding members 430 are engaged with the end portion of the holding member 340 as shown in FIG. 47.

Further, as shown in FIGS. 40 and 41, the screw 436 is screwed into the screw hole 432 of the holding member 430. At this time, by adjusting the tightness of the screw 436 to adjust the distance between the head of the screw 436 and the screw hole 432 of the guide rod holding member 430, it is possible to change the distance between the mounting portion 343 and the circumferential surface of the second guide rod 372, namely, the height of the right end portion of the pick-up base 370, whereby it becomes possible to adjust the tangential skew of the optical pick-up 351.

In this way, because the skew adjustment mechanism 42 of the present embodiment is constructed so that the tangential skew of the optical pick-up 351 is adjusted by changing the height of the second guide rod 372 with respect to the holding member 340, it becomes possible to easily adjust the tangential skew even after the optical pick-up 351 is mounted to the first guide rod 371 and the second guide rod 372.

Hereinafter, a description will be made with regard to the operation of the optical pick-up 35.

When the rotation shaft 362 of the sled motor 360 is rotated clockwise when viewed from the tip thereof, the worm wheel 363 is rotated counterclockwise when viewed along the axial direction via the worm 361, and this moves the rack gear 365 backward. As a result, the optical pick-up 351 is moved from the inner periphery to the outer periphery of the optical disc. On the other hand, when the rotation shaft 362 of the sled motor 360 is rotated in the opposite direction, namely, in the counterclockwise direction, the operations described above are reversed to move the optical pick-up 351 from the outer periphery toward the inner periphery. In this connection, it should be noted that the present invention is not limited to the arrangement of the present embodiment, and the worm 361 may be formed with left-hand threaded teeth.

In this connection, the rotation shaft 362 of the sled motor 360 is provided with a small amount of play in the axial direction to enable the rotation shaft 362 to rotate smoothly. Therefore, the rotation shaft 362 can be displaced slightly forward or backward within the range of such play. Consequently, when the sled motor 360 is rotated in the clockwise direction (i.e., the direction in which the optical pick-up 351 is moved to the outer periphery of the disc) or the counterclockwise direction when viewed from the tip of the rotation shaft 362, the rotation shaft 362 is displaced by being pulled toward the tip side (forward) or the base side (backward) within the range of the play.

In view of this problem, in the present embodiment, the tip end of the rotation shaft 362 is provided with a thrust load pushing mechanism 38 which biases the rotation shaft 362 from the tip side toward the base side in order to prevent the rotation shaft 362 of the sled motor 360 from being moved in the axial direction within the range of the play due to the rotation of the worm 361.

FIG. 21 is a top view showing an essential portion of the thrust load pushing mechanism 38 of the optical pick-up moving mechanism of the disc drive according to the present invention.

As shown in FIG. 21, the thrust load pushing mechanism 38 includes a pushing member 381 which makes contact with the tip of the rotation shaft 362, a compression coil spring 400 for pushing the pushing member 381 from the tip side to the base side of the rotation shaft 362, and support members 410 which support the pushing member 381 and the compression coil spring 400.

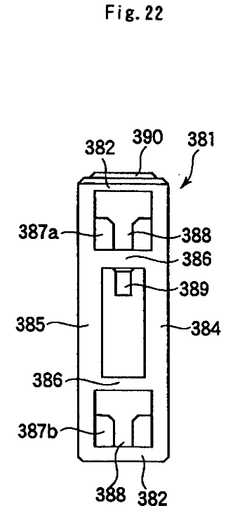

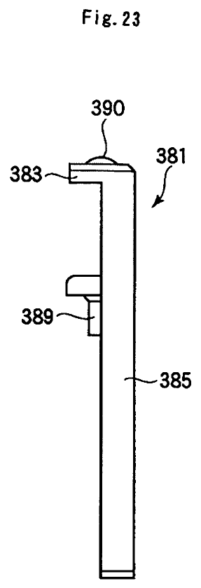

FIG. 22 and FIG. 23 are respectively a top view and a side view of the pushing member of the thrust load pushing mechanism of the disc drive according to the present invention.

As shown in FIG. 22 and FIG. 23, the pushing member 381 is formed into a roughly rectangular frame shape which includes a front rim portion 382, a rear rim portion 383, a left rim portion 385, a right rim portion 384, and two middle rim portions 386a, 386b positioned between the front rim portion 382 and the rear rim portion 383. Further, on the rear sides of the front rim portion 382 and each of the middle rim portions 386a, 386b, there are formed movement restricting portions 387a, 387b, respectively. Further, on the front side of the middle rim portion 386a, there is provided an engagement protrusion 389 which engages with the rear end portion of the compression coil spring 400. Furthermore, on the rear side of the rear rim portion 383, there is provided a sliding surface 390 which makes contact with the tip of the rotation shaft 362.

As shown in FIG. 22, the movement restricting portions 387a, 387b are positioned along the left rim portion 385 and the right rim portion 384, respectively, so as to create grooves 388, 388 therebetween which extend in the longitudinal direction. As described later, the grooves 388 engage with the support members 410 to restrict the movement of the pushing member 381.

As shown in FIGS. 22 and 23, the engagement protrusion 389 extends from the front side of the middle rim portion 386a toward the front. The engagement protrusion 389 engages with a center hole of the rear end portion of the compression coil spring 400, and carries out positioning of the compression coil spring 400. Further, the engagement protrusion 389 is provided so that the central axis of the engagement protrusion 389 is aligned with the center of the rotation shaft 362 and the central axis of the pushing member 381. The reason for this will be described later.

As shown in FIG. 23, the sliding surface 390 forms a bent surface which protrudes backward from the rear surface of the rear rim portion 383. The contact surface area between the sliding surface 390 and the tip of the worm gear 361 is made as small as possible to minimize the friction generated at such contact surface.

As shown in FIG. 19, the compression coil spring 400 is made from a coiled metal wire, and includes a center hole (not shown in the drawings) in the center portion along the longitudinal direction. This center hole engages with the engagement protrusion 389 provided on the pushing member 381 and an engagement protrusion 415 (described below) provided on the support members 410. Due to this engagement, it becomes possible to position the compression coil spring 400 on the pushing member 381 and the support members 410.

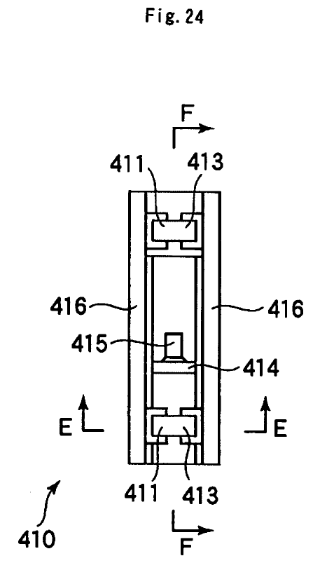

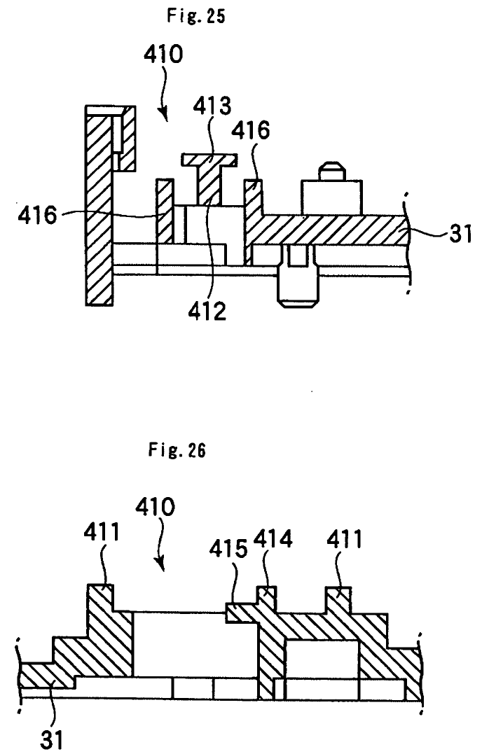

FIG. 24 is a top view of the support member of the thrust load pushing mechanism of the disc drive according to the present invention. Further, FIGS. 25 and 26 are cross-sectional views taken respectively along the line E-E and the line F-F of FIG. 24.

As shown in FIGS. 24 and 25, the two support members 410 are integrally formed with the bottom portion 341 of the holding member 340 and are arranged in the front and the rear. As shown in FIG. 26, each support member 410 includes guide portions 411, 411. Each of the guide portions 411, 411 is formed to have a roughly T-shaped horizontal cross section. The support member 410 further includes an engagement portion 414 positioned between the two guide portions 411, 411, and support portions 416, 416 positioned on the left and right sides of the guide portions 411, 411.

As shown in FIG. 24 through FIG. 26, each guide portion 411 is constructed from a restricting portion 412 which engages with the groove portion 388 formed between the movement restricting portions 387a (387b) of the pushing member 381 to restrict the movement of the pushing member 381 in the left and right directions, and a top surface portion 413 which is mounted to the top of the restricting portion 412 roughly orthogonal thereto. This top surface portion 413 makes contact with the top surface of the movement restricting portions 387 of the pushing member 381 to restrict the upward movement of the pushing member 381.

Further, as shown in FIG. 24, the engagement portion 414 includes an engagement protrusion 415 which extends backward from the rear surface thereof, and which engages with the front end portion of the compression coil spring 400. The engagement protrusion 415 is provided so that the central axis thereof is roughly aligned with the central axis of the rotation shaft 362 of the sled motor 360 mounted on the holding member 340. The reason for this is described later.

As shown in FIGS. 24 through 26, the top surfaces of the support portions 416, 416 form sliding surfaces, and the bottom surfaces of the left rim portion 385 and the right rim portion 384 of the pushing member 381 make contact with these sliding surfaces, respectively, so as to be able to slide along such sliding surfaces in the longitudinal direction.

Further, the rotation shaft 362 of the sled motor 360 is arranged so as to be roughly aligned with the center line of the pushing member 381 and the compression coil spring 400. Further, the center line of the engagement protrusion 389 of the pushing member 381 is arranged so as to be substantially aligned with the center line of the pushing member 381. Further, the central axis of the engagement protrusion 415 of the spring engagement portion 414 of the support member 410 is also arranged so as to be substantially aligned with the central axis of the rotation shaft 362 of the sled motor 360. Accordingly, the rotation shaft 362, the center line of the pushing member 381 and the center line of the compression coil spring 400 are substantially aligned with each other.

Now, because only the axial component of the restoring force of the compression coil spring 400 is transmitted to the rotation shaft 362 of the sled motor 360 in the arrangement described above, it is possible to prevent rattling when the optical pick-up 351 is moved, whereby it becomes possible to obtain a smooth operation of the optical pick-up 351, and it also becomes possible to increase the accuracy of the thrust load that pushes the rotation shaft 362.

The optical pick-up 351 is moved in the radial direction of the disc 10 by the optical pick-up moving mechanism 35 described above. The optical pick-up 351 is a horizontal type optical pick-up in which the reflected light from the disc 10 is bent at a right angle by a mirror (or prism) or the like and guided to a light receiving element, and includes an objective lens and an actuator (not shown in the drawings).

Further, the sled motor 360 of the optical pick-up moving mechanism 35 described above is controlled together with the spindle motor and a loading motor 601 (described below) by a control means provided on the printed circuit board.

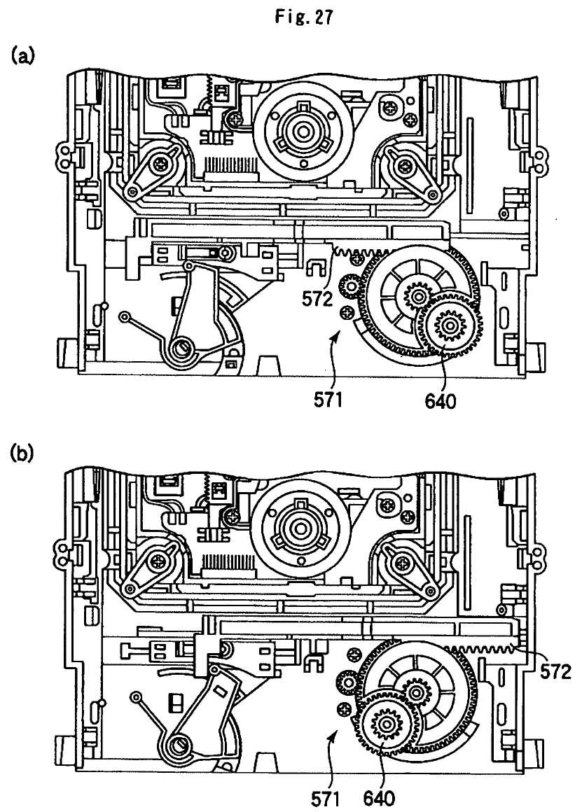

As shown in FIG. 2, a loading drive mechanism 57 is provided in front of the mechanism unit 32 to displace the mechanism unit 32 between a lowered position (see FIG. 27(a)) and a raised position (see FIG. 27(b)), and to convey the disc tray 51.

The loading drive mechanism 57 includes a cam mechanism 571 provided so as to be associated with the mechanism unit 32, a drive mechanism 60 for driving the cam mechanism 571 and the disc tray 51, a disc tray position detecting mechanism 670 which is associated with the cam mechanism 571, and an emergency ejection mechanism 56.

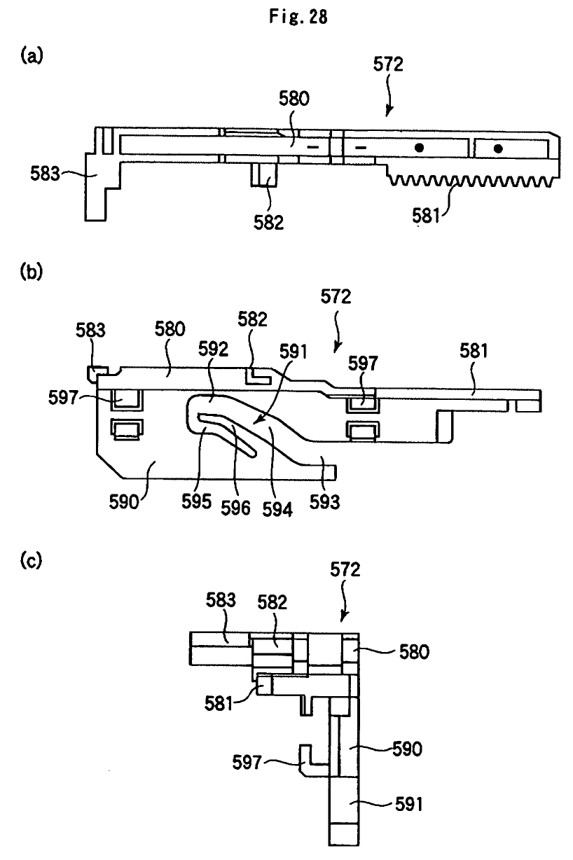

FIGS. 27(a) and 27(b) are top views showing the states in which the loading drive mechanism and a cam member of the cam mechanism of the disc drive according to the present invention are respectively at a first position and a second position. Further, FIGS. 28(a) through 28(c) are respectively a top view, a front view and a leftside view of the cam member.

When the cam mechanism 571 is at the first position shown in FIG. 27(a), the mechanism unit 32 is positioned at the lowered position, and when the cam mechanism 571 is at the second position shown in FIG. 27(b), the mechanism unit 32 is positioned at the raised position, whereby the turntable 321 is moved up and down.

In more specific detail, as shown in FIGS. 27(a) and 27(b), the cam mechanism 571 includes a cam member 572 which is arranged so as to be slidably moved in the left and right directions (i.e., the direction orthogonal to the moving direction of the disc tray 51) with respect to the chassis 31 between a first position (FIG. 27(a)) positioned at the left side and a second position (FIG. 27(b)) positioned at the right side of the chassis 31.

The cam member 572 is formed from a resin, and as shown in FIGS. 28(a) through 28(c), the cam member 572 is constructed from an upper portion 580 which includes a rack gear 581, a first protrusion 582 and a second protrusion 583, and a lower portion 590 provided roughly vertically from the rear edge of the upper portion 580 on the underside of the upper portion 580. The lower portion 590 includes a cam groove 591 for moving the mechanism unit 32 up and down, and a mounting portion 597 for mounting the cam member 572 to the chassis 31.

In more detail, as shown in FIG. 28(a), in the upper portion 580, the rack gear 581, the first protrusion 582 and the second protrusion 583 are provided on the front surface so as to extend toward the front.

As shown in FIGS. 28(a) and 28(b), the rack gear 581 is provided in a roughly linear state in the left and right directions from the right end portion of the upper portion 580, and meshes with a gear portion 653 provided on a gear arm 650 described later, so that the rotational movement of the gear arm 650 is converted to linear movement of the cam member 572 in the left and right directions.

As shown in FIG. 28(a), the first protrusion 582 and the second protrusion 583 extend toward the front from roughly the middle portion and the left end portion of the front surface of the upper portion 580, respectively.

When the cam member 572 is moved from the second position to the first position, the first protrusion 582 makes contact with a slider 680 described below, whereby the slider 680 is moved to the left side of the chassis 31.

Further, when the cam member 572 is moved from the first position to the second position, the second protrusion 583 pushes a detection lever 673 of a disc tray position detecting switch 671 described later, and by pushing an emergency cam 562 described later, the cam member 572 is moved from the second position to the first position, namely, from the right side of the chassis 31 to the left side thereof.

As shown in FIG. 28(b), the lower portion 590 is formed with the cam groove 591 for guiding the guide pin 336 provided on the mechanism unit 32, and two mounting portions 597, 597 for mounting the cam member to the chassis 31.

When the cam member 572 is mounted to the chassis 31, the cam groove 591 includes an upper groove 592 positioned at the left side of the chassis 31 when the cam member 572 is mounted to the chassis 31, a lower groove 593 having an open right-side end portion positioned at the right side of the chassis 31 when the cam member 572 is mounted to the chassis 31, an inclined groove 594 which connects the upper groove 592 and the lower groove 593, and a narrow groove portion 595 connected to the end portion of the upper groove 592. The bottom surfaces of the upper groove 592 and the inclined groove 594 are the top surface of an elastic portion 596 formed by the provision of the narrow groove portion 595, and this elastic portion 596 can be displaced up and down. This arrangement makes it possible to smoothly guide the mechanism unit 32 up and down by the cam member 572.

The guide pin (driven member) 336 provided on the front surface of the base frame 330 of the mechanism unit 32 is inserted into the cam groove 591. The guide pin 336 slides up and down along the cam groove 591 in accordance with the movement of the cam member 572 between the first position and the second position.

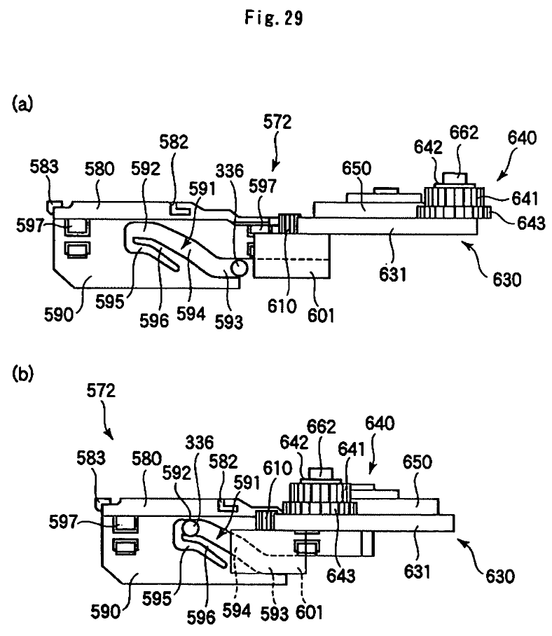

Namely, in the case where the cam member 572 is positioned at the first position, the guide pin 336 is engaged with the lower groove 593 (FIG. 29(a)), and the front portion of the mechanism unit 32 is positioned at the lowered position. When the cam member 572 is moved from the first position to the second position, the guide pin 336 is raised along the inclined groove 594, whereby the front portion of the mechanism unit 32 is raised upward from the lowered position toward the raised position. Further, when the cam member 572 reaches the second position, the guide pin 336 engages with the upper groove 592 (FIG. 29(b)), and the front portion of the mechanism unit 32 is displaced to the raised position.

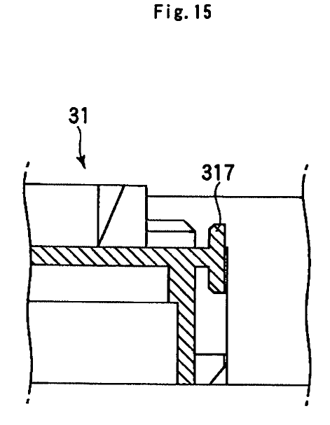

As shown in FIG. 28(b), one of the mounting portions 597 is provided on the left side of the front surface of the lower portion 590 and the other mounting portion 597 is provided on the right side thereof, and as shown in FIG. 28(c), the vertical cross section thereof forms a hook shape. Further, these mounting portions 597 are engaged with two rails 317 (see FIGS. 14 and 15) each having a rough T-shaped vertical cross section formed in front of the opening 312 of the chassis 31, so that the cam member 572 is mounted to the chassis 31 in a manner that enables the cam member 572 to be slidably guided in the left and right directions of the chassis 31.

Further, the disc tray position detecting mechanism 670 detects the position of the disc tray 51 by pushing the disc tray position detecting switch 671 (described later) by the first protrusion 582 and the second protrusion 583 provided on the upper portion 580 of the cam member 572, and the slider 680 which slides on top of the chassis 31.

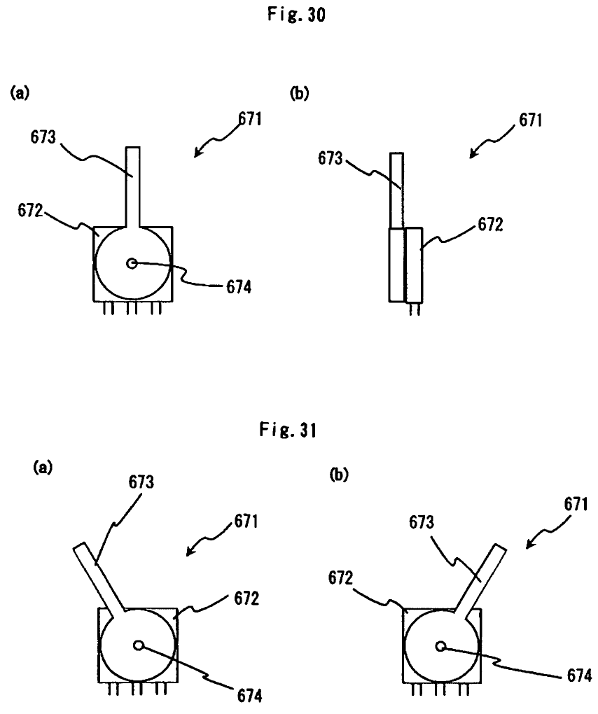

FIGS. 30(a) and 30(b) are respectively a front view and a side view of the disc tray position detecting switch 671, and FIGS. 31(a) and 31(b) are front views respectively showing the states of the disc tray position detecting switch 671 when a detection lever 673 is inclined to the left side and the right side.

As shown in FIGS. 30(a) and 30(b), the disc tray position detecting switch 671 includes a support portion 672 and the detection lever 673 pivotally mounted to the support portion 672. The detection lever 673 is mounted to a center shaft 674 of the support portion 672 so as to be capable of pivoting in the left and right directions around the center shaft 674. Further, in the state where an external force is not applied to the detection lever 673, the detection lever 673 is in a position roughly orthogonal to the top surface of the support portion 672 as shown in FIG. 30(a) due to a biasing force applied thereto by a spring or the like. As will be described later, this forms an OFF state of a first contact point and a second contact point.

Further, in the case where an external force is applied from the left side, the detection lever 673 is inclined to the right side as shown in FIG. 31(a) to turn on the first contact point. On the other hand, in the case where an external force is applied from the right side, the detection lever 673 is inclined to the left side as shown in FIG. 31(b) to turn on the second contact point. In this case, one of the ON states of the first contact point and the second contact point indicates that the disc tray 51 has reached the loading position, and the other indicates that the disc tray has reached the ejection position, and the first and second contact points are connected to the circuit of the substrate (not shown in the drawings) on which the disc tray position detecting switch 671 is mounted.

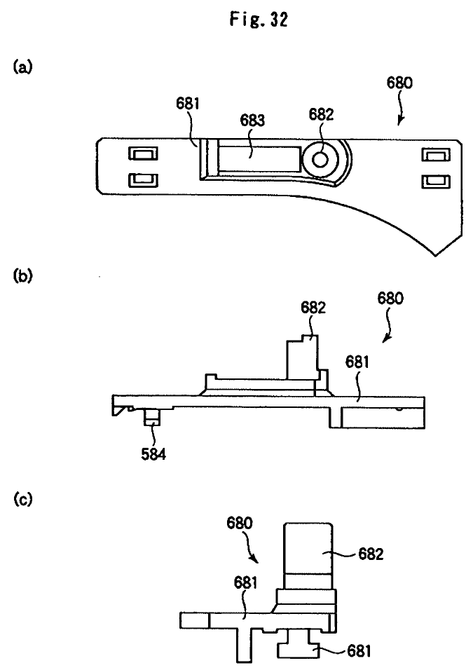

FIGS. 32(a) through 32(c) are respectively a top view, a front view and a side view of the slider of the disc tray position detecting mechanism of the disc drive according to the present invention.

The slider 680 is formed from a resin, and as shown in FIGS. 32(a) through 32(c), the slider 680 includes a plate-shaped body portion 681, a pushing plate 682 which extends upward from the top surface of the body portion 681, a protruding opening 683 through which the detection lever 673 of the disc tray position detecting switch 671 protrudes out, and a mounting plate 684 having a roughly T-shaped vertical cross section which extends downward from the bottom surface of the body portion 681. When the disc tray 51 is loaded, the pushing plate 682 uses the leftward force transmitted from the cam member movement restricting rib 520 provided at the rear of the bottom surface of the disc tray 51 to push the disc tray position detecting switch 671 to the left side. Further, the mounting plate 684 engages with a sliding groove 318 (see FIG. 14) provided in the chassis 31 so that the slider 680 is guided in the left and right directions of the chassis 31.

Hereinbelow, a description will be made with regard to the operation of the disc tray position detecting mechanism 670.

In the case where the cam member 572 is at the first position (FIG. 27(a)), namely, in the case where the disc tray 51 is at the ejection position, the pushing plate 682 of the slider 680 is pushed toward the left by the slider movement restricting rib 520 of the disc tray 51, and the detection lever 673 of the disc tray position detecting switch 671 is pushed toward the left by the slider 680. In this state, the first contact point of the disc tray position detecting switch 671 is turned on, whereby it is possible to detect that the disc tray 51 is at the ejection position.

In this state, when the disc tray 51 is moved backward by a disc tray loading operation, the slider 680 which was pushed toward the left by the slider movement restricting rib 520 is moved to the right by the restoring force exerted on the detection lever 673 of the disc tray position detecting switch 671.

Furthermore, when the cam member 572 is moved from the first position to the second position in accordance with the backward movement of the disc tray 51, the second protrusion 583 provided on the upper portion 580 of the cam member 572 pushes the detection lever 673 of the disc tray position detecting switch 671 to the right side. By this pushing operation, the second contact point is turned on, so that it is possible to detect that the disc tray 51 is at the loading position.

Moreover, when the disc tray 51 is moved forward from this state, the cam member 572 is moved from the second position to the first position in accordance with the movement of the disc tray 51. Then, because the second protrusion 583 is moved toward the left at this time, the disc tray position detecting switch 671 which was pushed toward the left by the second protrusion 583 is returned to the state shown in FIG. 30(a) by the restoring force of the spring, and the slider 680 is moved toward the left to a prescribed position by the first protrusion 582.

When the disc tray 51 is further moved forward and the guiding slant surface 521 of the disc tray movement restricting rib 561 provided on the bottom surface of the disc tray 51 makes contact with the pushing plate 682 of the slider 680, the slider 680 is moved toward the left. Namely, because the guiding slant surface 521 is inclined to the left side with respect to the longitudinal direction of the disc tray 51 as shown in FIG. 12, the pushing plate 682 is moved to the left side along the guiding slant surface 521. Then, the detection lever 673 of the disc tray position detecting switch 671 is pushed toward the left by the leftward movement of the slider 680, and thereby the first contact point is turned on, so that the ejection position of the disc tray 51 is detected.

In this way, because the structure for detecting the disc ejection position of the disc tray position detecting mechanism of the present embodiment does not use the displacement of the cam member like that of the prior art disc drive, the pin of the cam member and the rear portion of the guide groove of the disc tray which engages therewith can be formed in a linear state. Consequently, there is no risk that the movement of the disc tray will be hindered due to the locking of the pin of the cam member and the guide groove which was caused in the prior art disc drive which is provided with a curved portion at the rear portion of the guide groove of the disc tray. Further, this also makes it possible to smoothly load a disc by hand into the inside of the disc tray.

As shown in FIGS. 29(a) and 29(b), the loading drive mechanism 57 includes a loading motor 601 which is a DC motor capable of forward and reverse rotation provided on the underside surface of the front portion of the chassis 31, a pinion gear 610 mounted to the rotation shaft 602 of the loading motor 601, a first gear 630 having a large gear 631 which is rotatably provided on a first rotation shaft 314 integrally formed with the chassis 31 and meshes with the pinion gear 610 and a small gear 632 which is fixed coaxially above the large gear 631, a gear arm 650 which is fixed to the first rotation shaft 314 together with the first gear 630 and which includes a gear portion 653 which meshes with the rack gear 581 of the cam member 572 and a second rotation shaft 315 for rotatably mounting a second gear 640 (described later), and the second gear 640 which is mounted to the second rotation shaft 315 integrally formed on the gear arm 650 and which includes an intermediate diameter lower gear 643 which meshes with the small gear 632 of the first gear 630 and an upper gear 641 having a smaller diameter than the lower gear 643 and integrally formed coaxially with the lower gear 643.

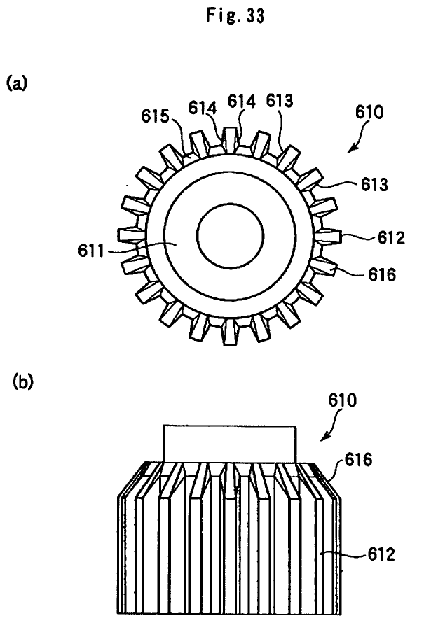

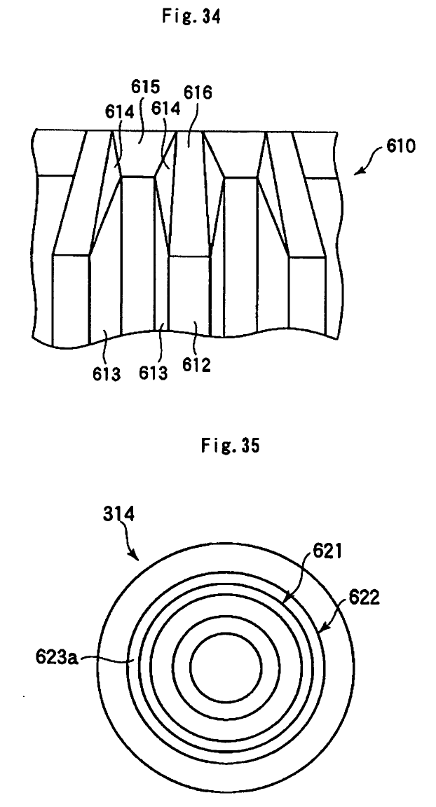

FIGS. 33(a) and 33(b) are respectively a top view and a side view of the pinion gear of the loading drive mechanism of the disc drive according to the present invention. Further, FIG. 34 is an enlarged perspective view of an essential portion of the pinion gear.

The pinion gear 610 is a drive gear which transmits the rotational force of the loading motor 601 to the large gear 631 of the first gear 630, and as shown in FIGS. 33(a) and 33(b), the pinion gear 610 includes a roughly cylindrical body portion 611, and a plurality of teeth 612 provided on the outer circumferential surface of the body portion 611. Each of the teeth 612 includes two tooth surfaces 613, 613.

As shown in FIG. 33(b) and FIG. 34, each tooth 612 has guiding surfaces 614, 614 which are continuously formed with the top ends of each of the two tooth surfaces 613, 613, respectively.

The guiding surfaces 614, 614 are provided to guide the teeth of the large gear 631 which is a matching gear that meshes with the pinion gear 610, and as shown in FIG. 33(b), the guiding surfaces 614, 614 are provided to respectively form an obtuse angle with respect to the two tooth surfaces 613, 613, whereby the lower end portions of the teeth of the large gear 631 are smoothly guided from the guiding surfaces 614, 614 to the tooth surfaces 613, 613.

Further, as shown in FIG. 34, a guiding groove 615 is provided between the adjacent guiding surfaces 614, 614 by connecting the inner edges (positioned at the side of the axis of the gear) of the adjacent guiding surfaces 614, 614. These grooves 615 serve to guide the teeth of the large gear 631 when the large gear 631 is assembled to the pinion gear 610.

Furthermore, the upper end portion of each of the teeth 612 is formed with a chamfer surface 616 arranged so as to form an acute angle with respect to the outer circumferential surface of the body portion 611. The chamfer surfaces 616 are provided to avoid protrusions such as burrs and the like at the lower end portion of the large gear 631 which meshes with the pinion gear 610, so that it is possible to prevent hindrances such as damage to both gears, poor rotation and the like from occurring.

Further, in the present embodiment, the guiding surfaces 614 and the chamfer surfaces 616 were formed as planar surfaces, but the present embodiment is not limited to such structure, and these surfaces may also be formed as curved surfaces. Further, the pinion gear 610 is formed from a material having a higher hardness than the large gear 631. Therefore, in the case where the large gear 631 is made to mesh with the pinion gear 610, it is difficult for the pinion gear 610 to be damaged by protrusions such as burrs and the like created on the end portion of the large gear 631.

Further, when the pinion gear 610 and the large gear 631 are to be meshed together upon assembly, because the pinion gear 610 is fixed to the loading motor 601, the large gear 631 is inserted on the first rotation shaft 314 and is moved downward along the central axis of the rotation shaft 314, whereby the large gear 631 is meshed with the pinion gear 610.

Further, in the present embodiment, the guiding surfaces 614, the guiding grooves 615 and the chamfer surfaces 616 were provided on the end portion of the pinion gear 610, but it is also possible to provide these on the end portion of the large gear 631.

As shown in FIGS. 27 and 29, the first gear 630 and the gear arm 650 are provided on the first rotation shaft 314.

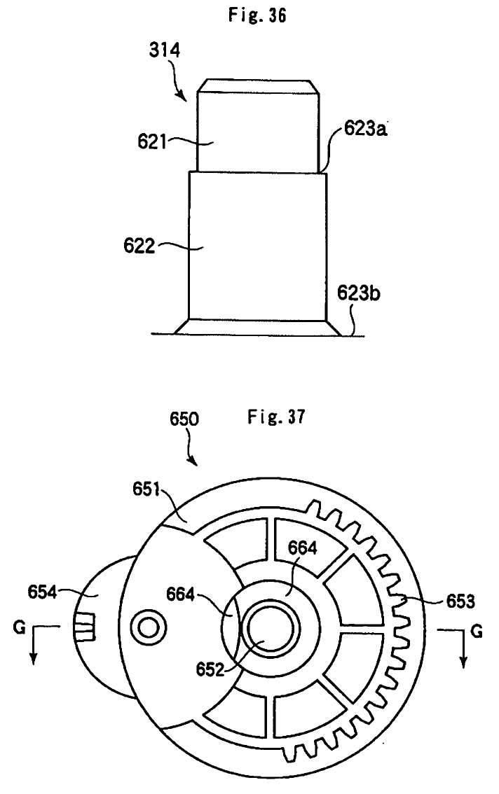

FIGS. 35 and 36 are respectively a top view and a side view of the first rotation shaft of the loading drive mechanism of the disc drive according to the present invention.

As shown in FIGS. 35 and 36, the first rotation shaft 314 includes a small diameter upper rotation shaft 621, and a large diameter lower rotation shaft 622 coaxially positioned below the upper rotation shaft 621. Further, a support surface 623a for supporting the gear arm 650 mounted to the upper rotation shaft 621 is provided between the upper rotation shaft 621 and the lower rotation shaft 622. Further, a support surface 623b for supporting the first gear 630 mounted to the lower rotation shaft 622 is provided on the bottom portion of the lower rotation shaft 622.

On the other hand, a center hole having roughly the same diameter as the lower rotation shaft 622 is formed in the first gear 630, and as shown in FIG. 37, a center hole 652 having roughly the same diameter as the upper rotation shaft 621 is formed in the gear arm 650. Further, because the first gear 630 is supported on the support surface 623b, and the gear arm 650 is supported on the support surface 623a, the first gear 630 and the gear arm 650 both mounted to the first rotation shaft 314 can be rotated smoothly without mutual contact and interference therebetween.

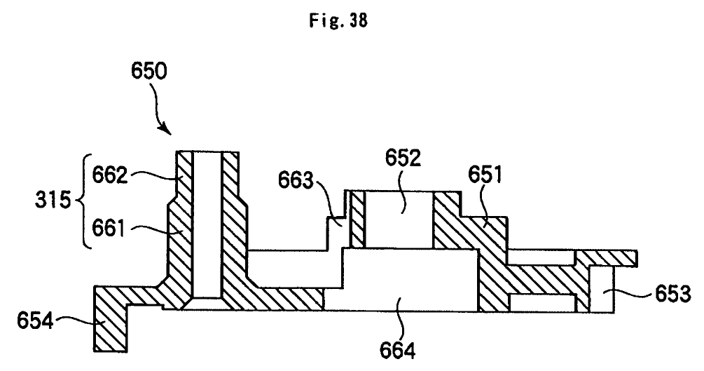

FIG. 37 is a bottom view of the gear arm of the loading drive mechanism of the disc drive according to the present invention. Further, FIG. 38 is a cross-sectional view taken along the line G-G of FIG. 37.

As shown in FIGS. 37 and 38, the gear arm 650 is formed from plastic to have a roughly disc shape, and includes a body portion 651 which includes a protruding portion 654 on a peripheral portion thereof, a center hole 652 for mounting the body portion 651 to the first rotation shaft 314 which forms the center of rotation thereof, an arc-shaped gear portion 653 formed on the bottom surface of he body portion 651 at the opposite side of the protruding portion 654 with the center hole 652 therebetween, and the second rotation shaft 315 which extends roughly vertically from the top surface of the protruding portion 654.

Further, the bottom portion of the center hole 652 of the body portion 651 is formed with a housing portion 664 which houses the small gear 632 positioned on the top portion of the first gear 630, and a small gear protrusion opening 663 for protruding a part of the small gear 632 from the housing portion 664 to the top surface of the body portion 651.

The second rotation shaft 315 includes a shaft portion 661 for mounting the second gear 640, and a pin portion 662 positioned on the top portion of the shaft portion 661 to engage with the guide groove 550 of the disc tray 51 so that the gear arm 650 is rotated by the guiding of the guide groove 550.

In the present embodiment, each of these gears is formed as a flat gear, and all the rotation axes have a mutual parallel positional relationship. By combining these gears, it is possible to construct the rotation speed reduction mechanism of the loading motor 601 in the loading drive mechanism 57.

Further, in the present embodiment, each of the guiding surfaces 614 is formed as a flat surface, but the present invention is not limited to the present embodiment, and it is also possible to form the guiding surfaces 614 as curved surfaces. Further, in the present embodiment, a flat gear is used for each gear, but the present invention is not limited to the present embodiment, and it is also possible to use other gears such as bevel gears.

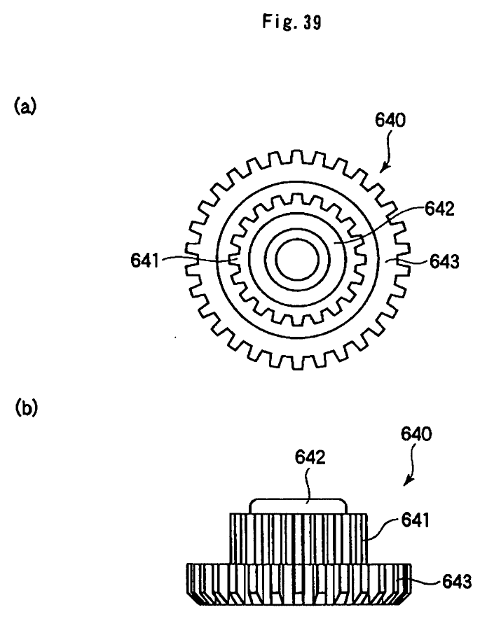

FIGS. 39(a) and 39(b) are respectively a top view and a side view of the second gear 640 of the loading drive mechanism of the disc drive according to the present invention.

The second gear 640 is formed from plastic, and as shown in FIGS. 39(a) and 39(b), the second gear 640 includes an intermediate diameter lower gear 643 which meshes with the small gear 632 of the first gear 630, and an upper gear 641 which has a smaller diameter than the lower gear 643, and which is integrally formed coaxially with the lower gear 643.

As shown in FIGS. 39(a) and 39(b), the top surface of the upper gear 641 is provided with an annular contact portion 642 which protrudes upward from the top surface of the upper gear 641.

When the second gear 640 is mounted to the second rotation shaft 315 of the gear arm 650, and the pin portion 662 of the second rotation shaft 315 of the gear arm 650 is engaged with the guide groove 550 of the disc tray 51, the contact portion 642 faces the end surface of the guide groove 550. Then, in the case where the second gear 640 is moved upward, the contact portion 642 and the end surface of the guide groove 550 make contact, and this prevents the second gear 640 from being removed from the second rotation shaft 315.

In this way, in the disc drive 1 of the present embodiment, because the rack gear 540 and the guide groove 550 of the disc tray 51 are arranged parallel to each other, the gear arm 650 which is meshed with the rack gear and the second gear 640 which is engaged with the guide groove 550 are able to move smoothly, and this makes it possible to smoothly move the disc tray 51 by hand.

Further, in this embodiment, the upper surface 642 of the second gear 640 and the end surface of the guide groove 550 of the disc tray 51 face each other, and when the second gear 640 is moved upward, such movement is restricted by the end surface of the guide groove 550. This makes it possible to prevent the second gear 640 from being removed from the second rotation shaft 315 without the provision of a fixing means such as a screw or the like on the top end of the second rotation shaft 315. As a result, the number of components can be reduced, and it becomes possible to obtain a loading drive mechanism which is easy to mount.

Further, the bottom end portion of the lower gear 643 is formed with guiding surfaces, guide grooves and chamfer surface portions (not shown in the drawings) in the same manner as the pinion gear 610, and this makes it possible to smoothly mesh the lower gear 643 with the small gear 632 of the first gear 630.

Further, the second gear 640 is constructed as a planetary gear which rolls along the rack gear 540 of the disc tray 51, in which the first rotation shaft 314 forms a revolving shaft, the second rotation shaft 315 forms a rolling shaft, and the small gear 632 of the first gear 630 functions as a sun gear.

Further, as shown in FIGS. 37 and 38, the top surface of the body portion 651 of the gear arm 650 is formed with the small gear protrusion opening 663 for protruding a part of the small gear 632 of the first gear 630 to the top surface of the body portion 651, and the part of the small gear 632 that is exposed from the small gear protrusion opening 663 meshes with the lower gear 643 of the second gear 640.

Due to the structure described above, in the case where the upper gear 641 of the second gear 640 is meshed with the linear rack gear 541 of the disc tray 51, and the pin portion 662 of the gear arm 650 is engaged with the linear guide groove 551 of the disc tray 51, as shown in FIGS. 27(a) and 29(a), the cam member 572 meshed with the gear portion 653 of the gear arm 650 is positioned at the first position by the guiding of the gear arm 650, and the disc tray 51 is conveyed from the disc ejection position to the disc loading position by the rotation of the second gear 640.

Further, in the case where the upper gear 641 of the second gear 640 is meshed with the arc-shaped rack gear 542 of the disc tray 51, and the pin portion 662 of the gear arm 650 is engaged with the arc-shaped guide groove 552 of the disc tray 51, as shown in FIGS. 27(b) and 29(b), the cam member 572 meshed with the gear portion 653 of the gear arm 650 is moved from the first position to the second position by the guiding of the gear arm 650 and the second gear 640.

In more specific detail, as described above with regard to the cam member 572, while the disc tray 51 is moved between the disc ejection position and the disc loading position, the pin portion 662 of the second rotation shaft 315 of the gear arm 650 engages with the linear guide groove 551 of the disc tray 51, so that the gear arm 650 is in a state that it is not possible to rotate. Consequently, while the pin portion 662 of the gear arm 650 is engaged with the linear guide groove 551 of the disc tray 51, the second gear 640 is kept at the first position. Then, in this state, as shown in FIGS. 27(a) and 29(a), the second gear 640 engages with the linear rack gear 541 of the disc tray 51, and functions as a drive gear of the disc tray 51 for moving the disc tray 51 between the disc ejection position and the disc loading position by the rotation of the loading motor 601 transmitted via the first gear 630.

On the other hand, immediately before the disc tray 51 is moved up to the disc loading position, the pin portion 662 of the second rotation shaft 315 of the gear arm 650 engages with the arc-shaped guide groove 552 of the disc tray 51, and the gear arm 650 rotates along the arc of the arc-shaped guide groove 552. In this state, as shown by the dotted lines in FIGS. 27(b) and 29(b), the second gear 640 engages with the arc-shaped rack gear 542 of the disc tray 51, and functions as a planetary gear which moves along the arc of the arc-shaped rack gear 542 in accordance with the rotation of the loading motor 601. Then, in accordance with the rotation of the gear arm 650, the cam member 572 meshed with the gear portion 653 of the gear arm 650 is moved toward the right by the guiding of the gear arm 650, and in accordance with such movement, the mechanism unit engaged with the cam groove 591 of the cam member 572 is raised from the lowered position to the raised position.

Further, as shown in FIG. 2, the disc drive 1 is also provided with a disc tray emergency ejection mechanism 56. The disc tray emergency ejection mechanism 56 is provided for the sake of manually ejecting the tip of the disc tray in case that the disc tray 51 is stuck at the reproducing position when the loading motor 601 can not be operated due to a power failure or the like. The disc tray emergency ejection mechanism 56 is constructed so that by inserting a jig through the jig insertion hole 481 of the front bezel 46 and rotating the emergency cam 562 manually, the cam member 572 can be moved from the second position to the first position as shown in FIGS. 27(a) and 27(b), whereby the tip of the disc tray 51 can be ejected from the inside of the main unit 30 to the outside.

Next, the operation of the disc drive 1 of the present invention will be described. When the disc drive 1 is not being used, the empty disc tray 51 is in a state (at the disc loading position) where it is housed inside the casing 20 (inside the main unit 30). In this state, the mechanism unit 32 is at the raised position, and the cam member 572 is at the second position shown in FIGS. 27(b) and 29(b). Furthermore, the second gear 640 of the loading drive mechanism 57 is at the left end portion of the arc-shaped rack gear 542 of the disc tray 51 in an engaged state with the arc-shaped rack gear 542.

When an eject operation is carried out in this state, the loading motor 601 is rotated clockwise, and the gear arm 650 and the second gear 640 are rotated clockwise in the drawings around the first rotation shaft 314 via the rotational speed reduction mechanism. In this state, the second gear 640 functions as a planetary gear in which the first rotation shaft 314 forms a revolving shaft, and in accordance with the rotation of the second gear, the second gear 640 is moved with rotating toward the right along the arc of the arc-shaped rack gear 542. In accordance with the rotation of the gear arm 650, the cam member 572 meshed with the gear portion 653 of the gear arm 650 is moved from the second position shown in FIGS. 27(b) and 29(b) to the first position shown in FIGS. 27(a) and 29(a), whereby the mechanism unit 32 is moved from the raised position to the lowered position.

At this point in time, the second gear 640 and the pin portion 662 of the second gear 640 are moved respectively from the arc-shaped rack gear 542 and the arc-shaped guide groove 552 of the disc tray 51 to the linear rack gear 541 and the linear guide groove 551. In this way, when the pin portion 662 is moved to the linear guide groove 551, the sideways movement of the cam member 572 is restricted. Further, in accordance with this, the gear arm 650 is in a state where rotation is not possible, and at such position the second gear 640 operates as a drive gear for moving the disc tray 51. Consequently, the second gear 640 engages with the linear rack gear 541 of the disc tray 51, and the disc tray 51 is moved from the disc loading position (reproducing position) to the disc ejection position.

Then, when a disc 10 is placed on the disc holding portion 511 of the disc tray 51 ejected out from the opening 463 of the front bezel 46, and a loading operation is carried out, the loading motor 601 is rotated in reverse, namely, in the counterclockwise direction, and the second gear 640 is rotated in the counterclockwise direction (the reverse direction) in FIG. 27(a) via the rotational speed reduction mechanism. In accordance with this, the disc tray 51 is moved toward the rear (the backside of the main unit 30) up to the disc loading position. In this way, the disc 10 held in the disc holding portion 511 of the disc tray 51 in a positioned state is also conveyed to the disc loading position (reproducing position) inside the main unit 30.

While the disc tray 51 is loading, namely, while the disc tray 51 is moving backward, the second gear 640 is in engagement with the linear rack gear 541 of the disc tray 51. Consequently, the cam member 572 is kept at the first position in a state where it cannot be moved toward the second position. As a result, the gear arm 650 is kept at a prescribed position in a state where it can not rotate, and the second gear 640 rotates at such prescribed position and functions as a drive gear for moving the disc tray 51. Further, the front portion of the mechanism unit 32 is kept at the lowered position.

When the disc tray 51 gets close to the disc reproducing position, the pin portion 662 of the gear arm 650 and the second gear 640 are respectively moved from the linear guide groove 551 and the linear rack gear 541 to the arc-shaped guide groove 552 and the arc-shaped rack gear 542 where they are moved and rotated along the arc of the arc-shaped guide groove 552 and the arc-shaped rack gear 542. In this state, the second gear 640 engages with the arc-shaped rack gear 542 of the disc tray 51, and functions as a planetary gear which moves along the arc of the arc-shaped rack gear 542 in accordance with the rotation of the loading motor 601. Then, in accordance with the rotation of the gear arm 650, the cam member 572 meshed with the gear portion 653 of the gear arm 650 is moved toward the left by the guiding of the gear arm 650, and in accordance with such movement, the mechanism unit 32 engaged with the cam groove 591 of the cam member 572 is raised from the lowered position to the raised position.

Further, in the case where the disc 10 loaded inside the disc drive 1 is to be removed, a prescribed switch is operated, and the disc 10 is unloaded (ejected). At the time of this unloading, the operations described above are carried out in reverse.

It should be noted that the present invention is not limited to the embodiment of the disc drive described above, and it is possible to make various improvements and modifications without departing from the scope and spirit of the present invention as defined by the appended claims. Further, the present invention is not limited to an optical disc drive for a CD, DVD and the like, and it is of course possible to apply the present invention to other optical disc drives, magnetic disk apparatuses and the like.

Industrial Utilization

As described above, because the pinion gear as the drive gear of the present invention has guiding surfaces for guiding the large gear of the first gear as the mating gear to the tooth surfaces of the pinion gear, the teeth of the large gear can be guided to the tooth surfaces of the pinion gear smoothly by the guiding surfaces when these gears are mated. Therefore, it is difficult for these gears to be damaged when they are mated, the production cost of the drive gear can be reduced, and efficiency of production process of the drive gear can be improved.

What is claimed is:

1. A drive gear to be arranged on an axis for transmitting rotational force to a mating gear arranged on another axis, the drive gear being adapted to be mated with the mating gear by moving one of the drive gear and the mating gear in a state where the other gear of these gears is being fixed on the axis thereof, the drive gear comprising:
a roughly cylindrical body portion;
a plurality of teeth provided on the outer circumferential surface of the body portion, each of the plurality of teeth having two tooth surfaces and both end portions in the direction of the axis; and
guiding surfaces for guiding teeth of the mating gear when these gears are mated, each of the guiding surfaces being formed in at least the one end portion of each of the plurality of teeth of the drive gear.

2. The drive gear as claimed in clam 1, wherein each tooth surface having both ends at the end portions, and each of the guiding surfaces is continuously formed with the end of the tooth surface at the one end portion thereof so as to form an obtuse angle with respect to the tooth surface.

3. The drive gear as claimed in claim 2, wherein the guiding surfaces are continuously formed with the ends of the two tooth surfaces of each of the plurality of teeth, respectively.

4. The drive gear as claimed in claim 1, further comprising guiding grooves for guiding the teeth of the mating gear, each guiding groove being provided between the adjacent two teeth of the drive gear.

5. The drive gear as claimed in claim 4, wherein each guiding groove is continuously formed with the opposed guiding surfaces of the adjacent two teeth.

6. The drive gear as claimed in claim 1, wherein each of the plurality of teeth is formed with a chamfer surface at least at the one end portion thereof so as to form an acute angle with respect to the outer circumferential surface of the body portion.

7. The drive gear as claimed in claim 1, wherein the drive gear is formed from a material having a higher hardness than the mating gear.

8. A disc drive having the disc gear claimed in any one of the claims 1-7.
